(19) United States
(12) Patent Application Publication
(10) Pub. No.: US 2013/0275308 A1
(43) Pub. Date: Oct. 17, 2013

(54) SYSTEM FOR VERIFYING ELECTRONIC TRANSACTIONS

(71) Applicants: Vakis Paraskeva, Epsom Downs (GB); Nis Ranken, Cropredy (GB); Howard Lewis, Cropredy (GB); Anthony Jones, Solihull (GB); Robert Pocknell, Warwick (GB)

(72) Inventors: Vakis Paraskeva, Epsom Downs (GB); Nis Ranken, Cropredy (GB); Howard Lewis, Cropredy (GB); Anthony Jones, Solihull (GB); Robert Pocknell, Warwick (GB)

(73) Assignee: MOBAY TECHNOLOGIES LIMITED, Warwick (GB)

(21) Appl. No.: 13/824,459

(22) PCT Filed: Nov. 29, 2011
(86) PCT No.: PCT/GB2011/052352

§ 371 Date: Jul. 3, 2013

(30) Foreign Application Priority Data
Nov. 29, 2010 (GB) 1020203.4
Feb. 3, 2011 (GB) 1101874.4
Mar. 29, 2011 (GB) 1105212.3
Jun. 15, 2011 (GB) 1110046.8

(51) Int. Cl. G06Q 20/40

(52) U.S. Cl. CPC G06Q 20/401
USPC 705/71; 705/44

(57) ABSTRACT

The invention is an electronic payment system designed to capture payments from customers in an ecommerce environment, including on-line via a browser, a mobile browser or a mobile application, which can support any card payment method but can also integrate with e Wallets such as Pay Pal and Google checkout, and which enhances security for all parties using two factor two channel authentication and card fragmentation solutions, and which simplifies and enhances the payment process for shoppers and consumers.

### 1 FIELD OF THE INVENTION

The invention is a unique way for mobile devices such as smartphones to make both on-line and real world payments in a highly secure and convenient way.

### 2 SUMMARY OF THE INVENTION

The summary of the invention is that it is a system for verifying electronic transactions, the system comprising a first computer, a second computer and a payment gateway server, the first computer operable by a user to initiate a purchasing transaction, the purchasing transaction being processed by the payment gateway server in communication with the first computer, wherein the payment gateway server is operable to communicate with the second computer, the second computer operable by the user to confirm that the purchasing transaction was initiated by the user. The system could be one where the second computer is a portable device.

The system could be one where the confirmation that the purchasing transaction was initiated by the user includes entry by the user of a personal identification code into an application running on the second computer. The system could be one where the first computer is a portable device.

The system could be one where the first computer is operable to select an item for a purchasing transaction by scanning a bar code.

The system could be one where the purchasing transaction is sent to the payment gateway server in response to selection of an item for a purchasing transaction by scanning a bar code.

The system could be one where a primary account number (PAN) is arranged such that one part of the PAN is held on a portable device and another part of the PAN is held by a gateway server.

The system could be one where the parts of the PAN are reconstructed for the purpose of verifying the payment transaction.

The system could be one where the purchasing transaction is initiated with a web retailer, the web retailer being in communication with the first computer and with the payment gateway server.

The system could be one where the web retailer does not participate in the payment authorization process, or where payment card details are not provided to the web retailer.

The system could be one where the payment card details are stored on the payment gateway server. The system could be one where the payment gateway server is a mobay server. The system could be one where the mobay server is not a server of the payment card issuer. The system could be one where the mobay server is a server of the payment card issuer.

The system could be one where the second computer is operable to display information describing the transaction. The system could be one where the first computer is located in a shop.

A system for verifying electronic transactions, the system comprising a computer and a payment gateway server, the computer operable by a user to initiate a purchasing transaction using a first application running on the computer, the purchasing transaction being processed by the payment gateway server in communication with the first application running on the computer, wherein the payment gateway server is operable to communicate with a second application running on the computer, the second application running on the computer operable by the user to confirm that the purchasing transaction was initiated by the user. The system could be one where the computer is a portable device. The system could be one where the purchasing transaction was initiated by the user includes entry by the user into the second application running on the computer of a personal identification code. The system could be one where the computer is operable to select an item for a purchasing transaction by scanning a bar code. The system could be one where the purchasing transaction is sent to the payment gateway server in response to selection of an item for a purchasing transaction by scanning a bar code. The system could be one where a primary account number (PAN) is arranged such that one part of the PAN is held on a portable device and another part of the PAN is held by a gateway server. The system could be one where the parts of the PAN are reconstructed for the purpose of verifying the payment transaction. The system could be one where the purchasing transaction is initiated with a web retailer, the web retailer being in communication with the computer and with the payment gateway server. The system could be one where the web retailer does not participate in the payment authorization process. The system could be one where the payment card details are not provided to the web retailer. The system could be one where the payment card details are stored on the payment gateway server. The system could be one where the payment gateway server is a mobay server. The system could be one where the mobay server is not a server of the payment card issuer. The system could be one where the mobay server is a server of the payment card issuer. The system could be one where the computer is operable to display information describing the transaction. The system could be one where the computer is located in a shop.

A system for verifying electronic transactions, the system comprising a first computer, a second computer and a payment gateway server, the first computer operable by a first user to initiate a payment transaction, the payment transaction being processed by the payment gateway server in communication with the first computer, wherein the payment gateway server is operable to communicate with the second computer, the second computer operable by a second user to authorize receipt of the payment transaction. The system could be one where the second computer is a portable device. The system could be one where the authorization to receive the payment transaction includes entry by the second user of a personal identification code into an application running on the second computer. The system could be one where the first computer is a portable device.

A system for verifying electronic transactions, the system comprising a first set of computers, a second set of computers and a payment gateway server, the first set of computers each operable by a corresponding user to initiate a purchasing transaction, the purchasing transaction being processed by the payment gateway server in communication with the respective computer of the first set of computers, wherein the payment gateway server is operable to communicate with a corresponding computer in the second set of computers, the corresponding computer in the second set of computers operable by the user to confirm that the purchasing transaction was initiated by the user.

The system could be one where the second set of computers is a set of portable devices, or confirmation that the purchasing transaction was initiated by the user includes entry by the user of a personal identification code into an application running on the corresponding computer of the second set of computers. The system could be one where the first set of computers is a set of portable devices. The system could be one where any of the first set of computers is operable to select an item for a purchasing transaction by scanning a bar code. The system could be one where the purchasing transaction is sent to the payment gateway server in response to selection of an item for a purchasing transaction by scanning a bar code. The system could be one where the primary account number (PAN) is arranged such that one part of the PAN is held on a portable device and another part of the PAN is held by a gateway server. The system could be one where the PAN are reconstructed for the purpose of verifying the payment transaction. The system could be one where the purchasing transaction is initiated with a web retailer, the web retailer being in communication with one of the first set of computers and with the payment gateway server. The system could be one where the web retailer does not participate in the payment authorization process. The system could be one where the payment card details are not provided to the web retailer. The system could be one where the payment card details are stored on the payment gateway server. The system could be one where the payment gateway server is a mobay server. The system could be one where the mobay server is not a server of the payment card issuer. The system could be one where the mobay server is a server of the payment card issuer. The system could be one where the corresponding computer in the second set of computers is operable to display information describing the transaction. The system could be one where the first set of computers is located in a shop.

A system for verifying electronic transactions, the system comprising a set of computers and a payment gateway server, each computer in the set of computers operable by a corresponding user to initiate a purchasing transaction using a first application running on the corresponding computer, the purchasing transaction being processed by the payment gateway server in communication with the first application running on the corresponding computer, wherein the payment gateway server is operable to communicate with a second application running on the corresponding computer, the second application running on the corresponding computer operable by the user to confirm that the purchasing transaction was initiated by the user. The system could be one where the set of computers is a set of portable devices. The system could be one where the confirmation that the purchasing transaction was initiated by the user includes entry by the user into the second application running on the corresponding computer of a personal identification code. The system could be one where the corresponding computer is operable to select an item for a purchasing transaction by scanning a bar code. The system could be one where the purchasing transaction is sent to the payment gateway server in response to selection of an item for a purchasing transaction by scanning a bar code. The system could be one where a primary account number (PAN) is arranged such that one part of the PAN is held on a portable device and another part of the PAN is held by a gateway server. The system could be one where the PAN are reconstructed for the purpose of verifying the payment transaction. The system could be one where the purchasing transaction is initiated with a web retailer, the web retailer being in communication with the corresponding computer and with the payment gateway server. The system could be one where the web retailer does not participate in the payment authorization process. The system could be one where the payment card details are not provided to the web retailer. The system could be one where the payment card details are stored on the payment gateway server. The system could be one where the payment gateway server is a mobay server. The system could be one where the mobay server is not a server of the payment card issuer. The system could be one where the mobay server is a server of the payment card issuer. The system could be one where the corresponding computer is operable to display information describing the transaction. The system could be one where the corresponding computer is located in a shop.

A system for verifying electronic transactions, the system comprising a computer and a payment gateway server, the computer operable by a user to initiate a purchasing transaction using a first application running on the computer, the purchasing transaction being processed by the payment gateway server in communication with the first application running on the computer, wherein the payment gateway server is operable to communicate with a second application running on the computer, the second application running on the computer operable by the user to confirm that the purchasing transaction was initiated by the user, wherein the computer is a portable device, and wherein a primary account number (PAN) is arranged such that one part of the PAN is held on the portable device and another part of the PAN is held by the gateway server. The system could be one where the parts of the PAN are reconstructed for the purpose of verifying the payment transaction.

A system for verifying electronic transactions, the system comprising a computer and a payment gateway server, the computer operable by a user to initiate a purchasing transaction using a first application running on the computer, the purchasing transaction being processed by the payment gateway server in communication with the first application running on the computer, wherein the payment gateway server is operable to communicate with a second application running on the computer, the second application running on the computer operable by the user to confirm that the purchasing transaction was initiated by the user, wherein the computer is a mobile device, and when the user adds a card to their account associated with the payment gateway server the second application is operable to connect to the card Issuer and, using an authentication process with the card Issuer, the mobile device is issued with a certificate by the issuer allowing the user to use the card for future transactions via the mobile device, and wherein the certificate is only stored on the mobile device and is unique to the mobile device.

The system could be one where when executing a new transaction the mobile device contacts the Issuer using the certificate (after entering the application PIN) requesting authority to proceed with the payment, the device sends a signed request (signed using the certificate) including merchant and payment details, the Issuer responds with a one time use, time limited, Payment Token for the payment, the token is passed to the payment gateway server which authenticates the token with the Issuer to check that it is valid, and if valid the payment is processed. The system could be one where the token is passed to the payment processor which can also authenticate the token with the Issuer before processing the payment for added security.

A system for verifying electronic transactions, the system comprising a first computer, a second computer and a payment gateway server, the first computer operable by a user to initiate a purchasing transaction, the purchasing transaction being processed by the payment gateway server in communication with the first computer, wherein the payment gateway server is operable to communicate with the second computer, the second computer operable by the user to confirm that the purchasing transaction was initiated by the user, wherein the second computer is a mobile device, and when the user adds a card to their account associated with the payment gateway server the second computer is operable to connect to the card Issuer and, using an authentication process with the card Issuer, the mobile device is issued with a certificate by the issuer allowing the user to use the card for future transactions via the mobile device, and wherein the certificate is only stored on the mobile device and is unique to the mobile device. The system could be one where when executing a new transaction the mobile device contacts the Issuer using the certificate (after entering the application PIN) requesting authority to proceed with the payment, the device sends a signed request (signed using the certificate) including merchant and payment details, the Issuer responds with a one time use, time limited, Payment Token for the payment, the token is passed to the payment gateway server which authenticates the token with the Issuer to check that it is valid, and if valid the payment is processed. The system could be one where the token is passed to the payment processor which can also authenticate the token with the Issuer before processing the payment for added security.

A system for splitting/dividing up primary account numbers (PAN) wherein one part of the PAN is held on a portable device and another part of the PAN is held by a gateway server. The system could be one where the gateway server is a Mobay Payment Gateway server. The system could be one where when a shopper first enters a new Card number into the portable device the Card number is encrypted using a key provided by the gateway server. The system could be one where the encrypted card number is split The system could be one where during a payment the fragment of the PAN and or the Key is sent to the gateway server to reconstruct the PAN during a payment. The system could be one where the reconstructed PAN is then sent to a Payment Processor (PP) to complete the Payment. The system could be one where the complete card number in encrypted form is never stored at the gateway server.

A system for making payments whereby all parts of a divided PAN are reconstructed for the purpose of verifying the payment transaction.

The System could be one for splitting/dividing up primary account numbers (PAN) wherein one part of the PAN is held on a portable device and another part of the PAN is held by a gateway server. The system could be one where the gateway server is a Mobay Payment Gateway server. The system could be one where when a shopper first enters a new Card number into the portable device the Card number is encrypted using a key provided by the gateway server. The system could be one where the encrypted card number is split into two fragments, one stored on the gateway server and the other stored on the mobile device. The system could be one where during a payment the fragment of the PAN and or the Key is sent to the gateway server to reconstruct the PAN during a payment. The system could be one where the reconstructed PAN is then sent to a Payment Processor (PP) to complete the Payment. The system could be one where the complete card number in encrypted form is never stored at the gateway server.

A system for verifying electronic transactions, the system comprising a computer running an application and a payment gateway server, wherein when a shopper using the computer adds a card to their payment gateway server account the application can connect to the card Issuer and, using the authentication process with the Issuer, the computer is issued with a certificate by the issuer allowing them to use the card for future transactions via the computer. The system could be one where the computer is a mobile device. The system could be one where the this certificate is only stored on the computer and is unique to the computer. The system could be one where the payment gateway server is a Mobay payment gateway server. The system could be one where the authentication process occurs when the shopper adds a new card. The system could be one where the authentication process occurs during processing of a purchasing transaction. The system could be one where when executing a new transaction the computer contacts the Issuer using the certificate requesting authority to proceed with the payment. The system could be one where the computer contacts the Issuer using the certificate after the user enters an application PIN. The system could be one where the computer sends a signed request (signed using the certificate) including merchant and payment details. The system could be one where the Issuer responds with a one time use, time limited, Payment Token for the payment. The system could be one where the token is passed to the payment gateway server which authenticates the token with the Issuer to check that it is valid. The system could be one where if the token is valid the payment is processed.

The system could be one where the token is passed to the payment processor which can authenticate the token with the Issuer before processing the payment. The system could be one where the Issuer only sends the token to the payment gateway, which subsequently sends it to the Payment Processor. The system could be one where the Payment Processor then uses the payment token to process the payment either directly or via an Acquiring Bank. The system could be one where the card details are never passed around any network, just tokens. The system could be one where the user never enters Card details into the computer but instead a token representing the Card details is provided to the Shopper by the issuer to enter into the computer to represent the card. The system could be one where a Card Token and the Payment Token are used to make payments instead of Card details. The system could be one where the PAN's don't have to be visible to anyone except the Issuer and the token represents the PAN. The system could be one where the communications to the Issuer are direct or via the Issuer/Card Scheme network.

A system for authenticating the payment instrument of a payment instrument holder with an issuer, by adding the payment instrument to a payment gateway server, and verifying the authenticity of the payment instrument by issuing an authentication certificate.

A system for making payments wherein a computer contacts the issuer and requests a payment token for a payment to a merchant, the issuer provides a payment token for the payment to be made, and the token is passed to a payment gateway server which authenticates the token with the issuer and authenticates the transaction. The system could be one where the token is a time limited token. The system could be one where the token can be passed to the payment processor which can authenticate the token with the issuer before processing the payment.

### 3 BRIEF DESCRIPTION OF THE DRAWINGS

FIG. 1 Outlines the current process for taking an on-line payment

FIG. 2 outlines the Mobay™ Payment Gateway Overview

FIG. 3 outlines the Mobay Instore™ Payment process

FIG. 4 outline the Mobay™ real world payments process

FIG. 5 outlines the Mobay™ Peer to peer payment process

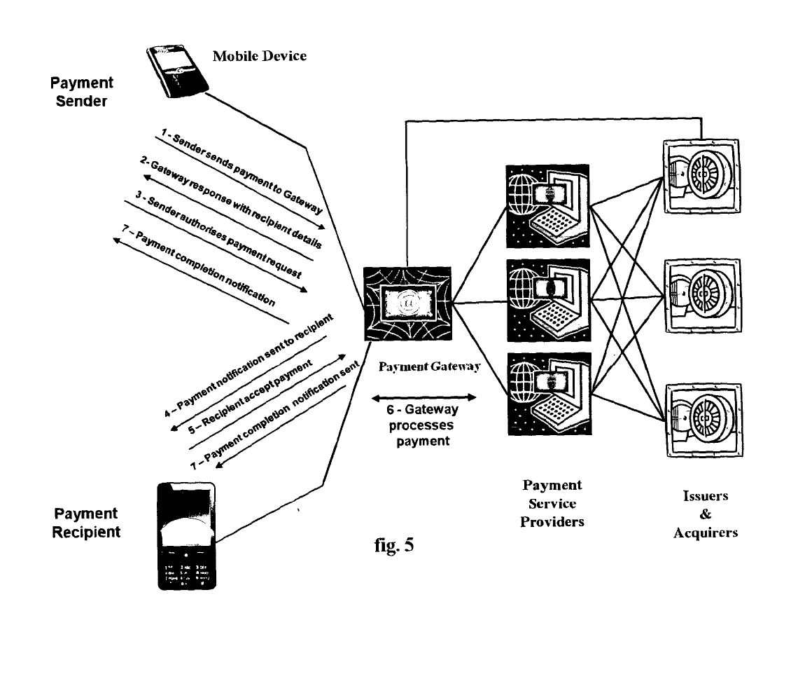

FIG. 6 outlines the key components of the Mobay Payment Gateway™ (MPG)

FIG. 7 outlines how an on-line Shopper uses the Mobay Payment Gateway™ to make a secure on-line payment using a standard web-browser and a suitable mobile device.

FIG. 8 shows the communications between the mobile device and the MPG to highlight the security aspects the transaction.

FIG. 9 outlines the Merchant authentication process.

FIG. 10 outlines the card handling process.

FIG. 11 outlines the PAN fragmentation process.

FIG. 12 shows where the Issuer fits into the PAN fragmentation process.

FIG. 13 outlines the payment processing using Issuer Authentication.

FIG. 14 outlines the Shopper Take-on process.

FIG. 15 shows the 3D Secure solution

FIG. 16 shows the process for the solution for access security

FIG. 17 shows detail of the process where there is multiple authentication

### DETAILED DESCRIPTION

Internet or on-line shopping has become a part of everyday life for most people and its use is rapidly increasing year on year. However, even though the ability to buy products via the internet has been possible for at least 10 years recent research has shown that 30% of UK shoppers still do not shop on-line because they do not trust on-line payments and a further 54% do not believe it is safe to do so. As well as the security issues with shopping on-line there is the inconvenience of having to enter your card and personal details onto many of the on-line shops visited. This has the effect of shoppers tending to use a small number of on-line Retailers even though there may be cheaper offers elsewhere. This also adds to the security threat as an ever increasing number of organisations are holding shoppers personal and financial details on their databases. To facilitate the ever increasing requirement for on-line payments a large number of organisations have been established globally providing e-commerce payment systems known as Payment Service Providers or PSP's. More recently mobile phones have been identified as a means for making payments in the real world. There are a number of initiatives and pilots looking at various ways of turning your mobile phone into a mobile wallet. As well as making payments other uses such as mobile ticketing for transport has been looked at, and technology such as NFC (near field communication) has been specified to handle small transactional value payments. So far mobile payments has been slow to take off especially in Europe and the US probably because shoppers do not see mobile payments as any more convenient than using current methods such as cash or credit cards. This is a key inhibitor for mobile payments as it requires shoppers to take steps to sign up to a mobile payments system unlike on-line payments. Also, due to the large number of players in the market including card schemes, card issuers, banks, Retailers and mobile phone operators a standard way of doing mobile payments could take time to agree.

### Current E-Commerce Payment Systems

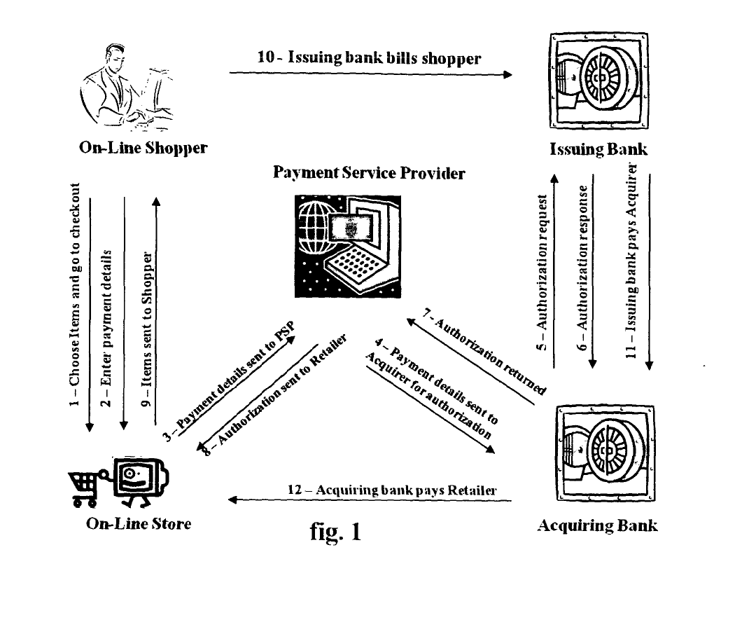

Current e-commerce payment systems follow roughly the same process for processing on-line payments. The diagram in FIG. 1 outlines this process. The process for taking an on-line payment works as follows with reference to the numbered arrows in FIG. 1. The shopper is on an on-line shopping website and chooses some items they wish to purchase. The shopper fills their virtual shopping cart with these items and proceeds to the virtual checkout. At the checkout the shopper enters their name, address, credit card details and shipping address they wish the items to be sent to. The on-line retailer will then send the payment details (which include card details and transaction amount) to a PSP for further processing. The PSP will send the card details to the Retailers bank or the Acquirer for authorisation. The Acquirer will send the transaction details to the issuing bank for authorisation. The issuing bank or Issuer is the bank that issued the card to the shopper. If the shopper has the available funds on their card the Issuer sends an authorisation code to the Acquirer. The Acquirer in turn sends that authorisation code to the PSP. The PSP informs the on-line retailer that the payment has been authorised. The retailer can now send the goods to the Shopper knowing they will get paid by the PSP. At some later stage the Issuer will request payment for this and other payments that have been made on the Shoppers card. The Issuer will pay the Acquirer for transactions authorised by the Issuer for transitions processed by the Acquirer. The Acquirer, usually via the PSP, pays the Retailer for the transaction. The final amount the Retailer receives for the transactions has a number of deductions taken from it. The PSP will have a costing structure agreed with the Retailer in advance and the details of this will usually depend on the size of the Retailer and the risk associated with the Retailer. Part of the Acquirers share of the transaction charge is then used to pay the Issuer for their services. Finally the Acquirer has to pay the Card Scheme (e.g. Visa) for using their authorisation network. So in this case both the Acquirer and the Issuer are connected to Visanet and use the Visa system to authorise and settle Visa card payments.

A large part of the cost for Retailers transacting on-line is the cost of fraud which is why a high premium is associated with fraud (or risk) checking. Some PSP's offer this service directly or use a third party organisation to provide it.

Risk checking essentially works by collecting data about card usage patterns over a fixed period of time. The system uses this data to assess the risk of the transaction and generates a risk score. This risk score can be used by the Retailer as a deciding factor of whether to accept a transaction or not.

A Retailer requires a Merchant Account with a bank to be able to accept card payments both on-line and off-line. Larger Retailers usually have a close relationship with their bank and would be reluctant to move their Merchant Account. Therefore PSP's will usually have links to at least all of the major banks to ensure they can attract the maximum number of potential Retailers.

Very small Retailers are unlikely to have a Merchant account or may even struggle to open an account. Most PSP's will therefore provide these smaller Retailers with a facility to take on-line payments via the PSP's account. This however is usually a more expensive way of processing transactions on-line.

### Security Threats of Current E-Commerce Systems

Regardless of the security measures put in place by the on-line retailers or the PSP the shopper is vulnerable using this model for making on-line payments. The shopper is susceptible to three or more key attacks that could result in their card details and other personal details being acquired by a third party with malicious intent.

The first of these attacks is known as the Man-in-the-Middle attack or MITM which is when an attacker compromises the network between the shopper's computer and the on-line retailer. This compromised network can be a home WiFi, the retailer's network or any component in between.

Once the network is compromised an attacker could manipulate the data travelling on the network to gain access to the shoppers personal and card details.

The second form of attack is the Man-in-the-Browser or MITB attack which is when a virus or Trojan is placed on the shopper's computer. There are many examples of this type of attack but essentially the virus or Trojan collects data directly from the Shoppers computer as it is being entered and sends it via the internet to the attacker which the attacker can use to make fraudulent payments.

A third type of attach is known as a Phishing attack, this is when the Shopper is tricked into divulging sensitive information such as username/passwords, card details, 3D secure passwords, one time passwords or other sensitive information. This could later be used by a fraudster to defraud the shopper. This can be done via bogus website that pretends to be legitimate retailer, bogus emails or other means.

### The Mobay™ System

The invention includes a new component added to the current e-commerce payment systems. The invention is an electronic payment system designed to capture payments from customers in an ecommerce environment. This includes on-line via a browser, a mobile browser or a mobile application. The invention can support any card payment method but can also integrate with eWallets such as PayPal™ and Google™ checkout. The invention enhances security for all parties using sophisticated security methods not presently available to existing eCommerce payments systems. The invention simplifies and enhances the payment process for shoppers and therefore reduces the dropout rate for merchants. The invention can process the captured payments using a Payment Services Provider (PSP) such as SagePay™ The invention provides at least four methods of integration:

1 Merchant direct. This is where the Merchant hosts the payment pages on their own website. In this mode the invention provides a payment API that a Merchant can use to send a payment request to the provider. The provider processes the payment via the Merchants PSP.
2 Mobay Hosted. This is where the Merchant website redirects the Shopper directly to the provider's hosted payments. The provider can host the payment page on behalf of the Merchant and processes the payment via the Merchants PSP.
3 PSP Hosted. This is where the PSP hosts the payment pages on behalf of the Merchant; in this case the Merchant does not need to integrate with the invention. In this mode the PSP integrates with the provider using the inventor PSP API to send payment requests on behalf of the Merchant to the provider.
4 Mobile API This is where mobile applications can accept payments via the Mobay In-Application API. In this mode of working the payment request is send directly to Mobay from within an application using the Mobile API.

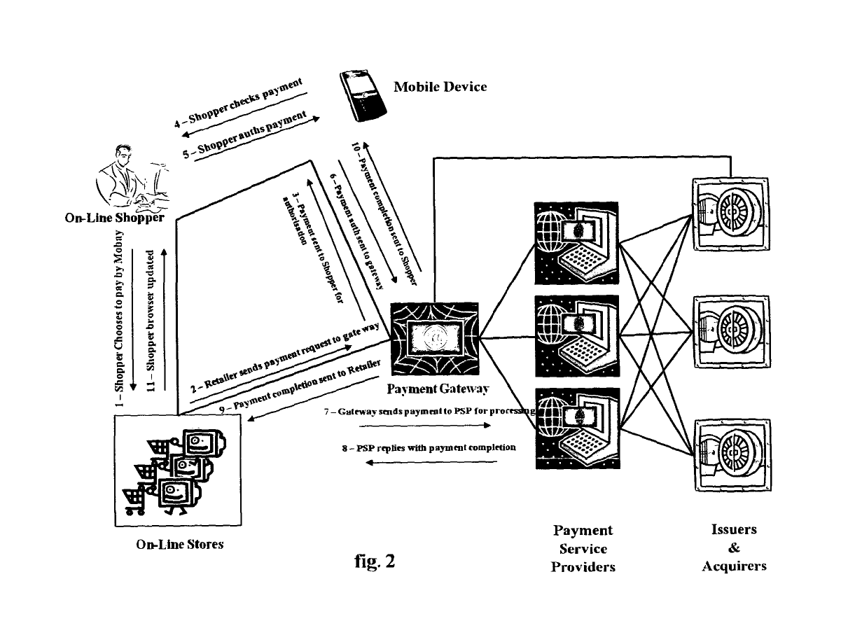

The gateway can sit between the Shopper and the Retailer and handles the payment on behalf of the shopper and the Retailer. The diagram in FIG. 2 outlines at a high level this process and its associated data flows.

The Payment Gateway is designed to link to any number of PSPs for payment processing. The details of how this is done will depend on the interfaces and protocols utilised by the PSP. In order to minimise the integration effort for Merchants and PSPs the method of the link may vary on a PSP by PSP basis.

Essentially Mobay can act as a proxy for the Merchants and will sit in front of their chosen PSP or PSPs. The Gateway will receive a request from the Merchant regarding a payment. The Gateway can authenticate with the Shopper and if successful will pass the authorisation request to the PSP. Upon successful authorisation the Gateway will then send a message to the Merchant and the Shopper indicating a completed payment. The Gateway will then hand control back to the Merchant website to allow the Shopper to continue browsing the Merchants website. During this process no card details are entered onto the Shoppers browser.

This approach has a number of key benefits to all parties involved in an online payment transaction. Firstly, Shoppers only need one application for their mobile device to pay for goods and services via their mobile device rather than an application for every mobile payment system out there. Secondly, it is beneficial to Merchants because they only need to deal with one mobile payment capture system whilst still being able to use their preferred payment service provider or providers. If the Merchant has more than one PSP then the gateway can load balance if required between two or more PSPs. Load balancing is when there are two or more available PSPs the gateway will cycle through each of them in turn using a predetermined algorithm. If one is out of service for whatever reason it is not used by the gateway). This gives two major benefits to the Merchant, increased resilience and increased throughput. Thirdly, this is beneficial to PSPs because it means they do not need to develop their own mobile capture systems and it means they do not miss out on payment capture revenue because they do not provide a mobile capture system. Finally, it is beneficial to all parties as by having a single system that serves all Merchants and PSPs the probability of gaining a critical mass of customers is much higher than disparate competing systems.

The Gateway can also connect directly with Acquirers to allow the gateway to perform all the functions that would normally be provided by a PSP. In the event of an unsuccessful authorisation the Shopper and the Merchant are both notified. If both parties agree, they can repeat the transaction using a different payment instrument if necessary.

The Mobay system provides a system of two channel two factor authentication. This provides a means for stopping Man-in-the-Middle attacks, Man-in-the-Browser attacks, Phishing attacks as well as many other forms of online and mobile attack.

During the payment process the Shopper is authenticated when they log in to the payment gateway via the browser using their unique Mobay Identification and password. This is the first channel and first factor of authentication and is currently used by many online retailers and payment providers such as PayPal. However, this system has a number of security flaws including being subject to Man-in-the-Middle and Man-in-the-Browser attacks. The second channel and second factor of authentication is when the Mobay gateway then communicates with the Shopper via their mobile device. The gateway sends the payment details to the mobile device in a data message that has been digitally signed and encrypted by the gateway. This message can only be decrypted by the Shoppers mobile device which means that the Shopper is confident of the source of the message and that the message has not been tampered with in any way. The Shopper can then visually examine and confirm what they are attempting to pay matches that which the gateway is asking them to pay. The message will include payment details such as amount, the goods or services they are purchasing and the Merchant they are attempting to pay. Again this allows the Shopper to confirm that the payment has not been tampered with in any way. If the Shopper is happy that the payment details are correct they accept the payment instruction by entering their PIN Code. The mobile device application will then digitally sign the Shopper authorisation and send an encrypted response back to the gateway. The gateway will then decrypt the response using a key associated with the Shopper which is the only key that can decrypt the response. This assures the gateway that the Shopper did in fact accept the payment and the Shoppers mobile device did in fact digitally sign and encrypt the response. When the Shopper first installs the application on the mobile device a unique key or keys used for digitally signing, encrypting and decrypting messages are installed on the device. These keys can be acquired in a number of ways, they can be sent electronically to the application from the server, they can be sent to the mobile device via SMS, they can be sent by email or they can be sent physically in the post or a combination of these methods. The payment instruments (Credit Card, Debit Card, Bank Accounts etc) will be stored on the gateways servers in an encrypted form (but may also be stored on the mobile device in the future in the SIM card for example) and never entered into the retailers browser. The gateway sends the payment instrument's details to the PSP after successfully authenticating the Merchant and the Shopper and obtaining a digitally signed acceptance from the Shopper. This prevents sensitive details regarding these payments instruments being intercepted by the attacks outlined above. In summary this system provides a method for parties, the Shopper, the Merchant & the PSP, to be sure that each party is authentic, the payment details have not been tampered with and that the Shopper has accepted the payment terms.

### The Mobile Device

The mobile device may be any device that can communicate with the server and is capable of displaying transaction details on a suitable display. In many cases this will be a mobile phone but it could equally be a PDA, a tablet device or a bespoke authentication device. One example of such a bespoke authentication device could be a device the size and weight of a credit card which has wireless capability. The device can have a display, with the ability to enter the PIN/password number and the card could have photo identification. It could still be used as a Chip and PIN device in the alternative. The device may be a touch screen device so that it isn't possible to tell which numbers have been regularly pressed.

### Mobay On-Line Payment Process

The process for taking an on-line payment with Mobay works as follows with reference to the numbered arrows in FIG. 2. The Shopper visits an on-line Retailers web-site and shops as usual by choosing items and adding them to their virtual shopping cart. When ready the Shopper goes to the sites checkout page. At the checkout page to Shopper clicks pay-by-Mobay as the payment method. If the Shopper is new to the on-line store or has not used the Mobay payment method before with this retailer they are prompted to enter their unique Mobay identification code. If they are not new to the store this will not be necessary as the retail web-site will “remember” their Mobay identification. As an added security feature the system can support the use of one time identification codes. The shopper requests this key from the mobile application before typing it into the web-site. Another additional feature is that the Shopper may need to enter their Mobay password. However, this will not be necessary when using one time identification codes.

FIG. 1 outlines the current process for taking an on-line payment works as follows with reference to the numbered arrows in FIG. 1. The shopper is on an on-line shopping website and chooses some items they wish to purchase. The shopper fills their virtual shopping cart with these items and proceeds to the virtual checkout. At the checkout the shopper enters their name, address, credit card details and shipping address they wish the items to be sent to. The on-line retailer will then send the payment details (which include card details and transaction amount) to a PSP for further processing. The PSP will send the card details to the Retailers bank or the Acquirer for authorisation. The Acquirer will send the transaction details to the issuing bank for authorisation. The issuing bank or Issuer is the bank that issued the card to the shopper. If the shopper has the available funds on their card the Issuer sends an authorisation code to the Acquirer. The Acquirer in turn sends that authorisation code to the PSP. The PSP informs the on-line retailer that the payment has been authorised. The retailer can now send the goods to the Shopper knowing they will get paid by the PSP. At some later stage the Issuer will request payment for this and other payments that have been made on the Shoppers card. The Issuer will pay the Acquirer for transactions authorised by the Issuer for transitions processed by the Acquirer. The Acquirer, usually via the PSP, pays the Retailer for the transaction.

At point 1, the payment details, the item details, the Merchant details and the Shoppers Mobay identification are sent to the Payment Gateway. At 2, upon receiving the payment request from the Gateway checks that the merchant is authorised to take payments via the Mobay Gateway (Merchant authentication) and that the Shopper Identification is a valid Mobay shopper, and if required the Shopper password is valid. At 3, if the payment request is valid the Gateway will send the details to the Shopper via their mobile payment device. The message will be sent using a push notification (Push notification is a method for sending a message to a specific application on a specific device) for maximum usability but other methods such as SMS can be used. If the Shopper cannot receive notifications or the notification does not arrive in a timely manner the user can start the application. When the application starts it checks with the Gateway for outstanding payment requests and if there is one it pulls the details for the Gateway. At 4, when the Shopper receives the notification on their mobile device they can choose to reject it if they were not expecting a payment request or do not agree with the request for any reason (e.g. they suspect fraud). Otherwise the Shopper chooses to view the payment request details. When the Shopper chooses to view the request the application automatically starts (or in the case the notification didn't arrive or the user started the application manually the application is already running). The Shopper is presented with a screen detailing the payment, including an optional list of items, optional pictures or other data, they are about to purchase along with the details of the Retailer and the payment amount. If the Shopper is happy with the payment requests the Shopper is guided through one of a number of screens or pages allowing them to choose the payment instrument (Card type or bank account etc.) and the shipping address. At 5, the Shopper presses the Pay button and is then prompted for their 4 (or more depending on the size of PIN chosen) digit PIN code (or password) associated with their Mobay account. The PIN code is just one of a number of measures in place to ensure Shoppers and Retailers are protected from security breaches and fraud. At 6, the mobile device sends the Shopper authorisation in a digital signed and encrypted message to the Payment Gateway. At 7, the Payment Gateway does a security check on the incoming message to confirm that the Shopper did in fact authorise the payment. Then the payment is sent to a PSP to process the payment as described in FIG. 1 from point 4 onwards with some exceptions. This time instead of the payment authorisation going directly to the Retailer (FIG. 1 point 8) it is returned to the Payment Gateway. The Payment Gateway then relays the payment authorisation to the Retailer. The Payment Gateway can also send a payment confirmation to the Shopper via SMS, Email or other means and/or a message on the Mobile device. The Retailers web-page is updated to show the Shopper that their purchase is now complete.

In an increasing number of situations the browser used by the Shopper and the Mobay payment application may reside on the same device. For instance a Shopper could be using their smart phone or tablet device to browse a retail website and still choose to pay by Mobay. In this scenario when the “pay by Mobay” button is pressed the device will receive the payment notification in the usual way. The browser may close and the Mobay mobile payment application will start. Once the payment process has completed the payment application will close and the Shopper redirected back to the retail website. This gives two key advantages to the payment process. Firstly, using the Mobay payment system is much more secure than relying on browser security because it avoids any security attacks against the browser and due to the security built into the application removes the possibility of man-in-the-middle attacks, phishing attacks and other attacks. Secondly, the Shopping experience is considerably simplified as using a dedicated payment application is much easier than trying to navigate a website on a mobile device. As with the current e-commerce payment process, at a later stage the Shoppers account is debited with the payment amount via their card issuing bank. This is then forwarded to the Acquirer (the payment authoriser) and in turn the Acquirer sends the funds to the Shoppers merchant account. For each step of this process the usual fees are deducted at each step.

### Direct to Checkout

The system also supports a direct to checkout method of purchases when shopping on-line by using encrypted digitally signed barcodes displayed on the website adjacent to products. If a shopper sees exactly what they are looking for they can scan the barcode with their mobile device on the screen for that product and purchase it directly without having to go to the checkout screen of the website.

Each time a product is scanned the mobile application is updated and the shopper can continue browsing the website for more items.

They can add one or more items by scanning them whilst browsing the online store and once they have everything they need they click the finish-and-pay button on their mobile device to make the purchase which essentially takes them to step 4 above.

This is another unique feature of the Mobay system that makes purchases on-line of goods and services both more convenient and more secure. If the user is browsing the retail website on their mobile device they can simply use the retail website shopping cart. When the shopper has finished shopping they can choose to pay by Mobay at that checkout screen as described above.

### Mobay In-Store Payment Process

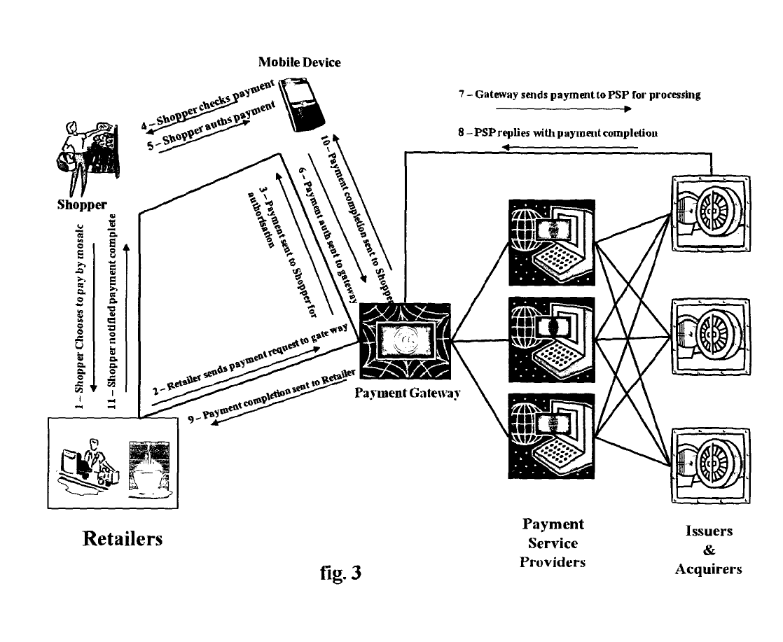

The Mobay Payment Gateway can also be used for making payments in the real world such as a bricks and mortar Retailer, a coffee shop, a bar or restaurant, or similar. The process is very similar to that used for an on-line payment as shown in FIG. 3. When making a payment in a store such as a retail store the process is as follows. At the point of sale (POS) the shopper presents their Mobay identification to the retailer. There are a number of ways this can be presented as follows: a) The Shopper tells the cashier their Mobay identification and the cashier types this into the POS device. To prevent any security issues this identifier may be a one time identifier generated by the mobile application. However, the identifier alone cannot be used to defraud the system. b) The Shopper types this into the POS device, again one time identifiers can be used for added security. This is not the same as the PIN code for any of the shopper credit or debit cards but an identifier that links the Shopper to their Mobay account. c) The Shoppers mobile device transmits the identification electronically, this can be done using NFC (Near Field Communication) or by generating a bar code representing the identification that is scanned by the POS device. For added security the mobile device generates a one time code using security features within the application. This removes the risk of malicious third parties from copying the identification and attempting to use it for fraudulent payments. However, this is just one of many security features built into the system and the Identification number alone cannot be used for making payments. The process of generating a unique one time Identification can also be applied for manual input described in a) and b) above but this will add an extra step for the shopper in that they will need to start up the application and request a one time key. The one time Identification code is generated in such a ways as to uniquely identify the Shopper and the device they are using at the time of the payment. The POS device sends the payment request to the Payment Gateway which as before authenticates the Retailer and confirms that the Shopper is a valid register user of the Mobay system. Later steps are the same as those described for the on-line payment method described above. The POS device notifies the cashier and the Shopper that the payment has been successfully completed. For added security the Shopper can register their picture with the Payment Gateway, this can be displayed to the retailer POS. The cashier will then have the option of rejecting the payment if the Shoppers appearance does not match that shown to the cashier. There could also be other or alternative added security, such as facial or audio analysis, or fingerprint reading, or other biometric analysis for example.

Most high street retailers will have Merchant accounts with Acquirers and may not have on-line accounts with PSPs. In either case it may be preferable for both cost, speed of processing and timing of payment remittance to communicate directly with the Acquirer that holds the Retailers merchant account. It is also possible that the Retailer may only have a relationship with a PSP, usually very small retailers. In this scenario the Payment Gateway will process the payment via the Retailers PSP as in the on-line scenario. For on-line retailers being able to take payments in the physical world will be very beneficial especially for small retailers. Using a simple payment application accessible on the Mobay website or through mobile device application, retailers can take payments from Mobay shoppers anywhere.

### Mobay Real World Payments

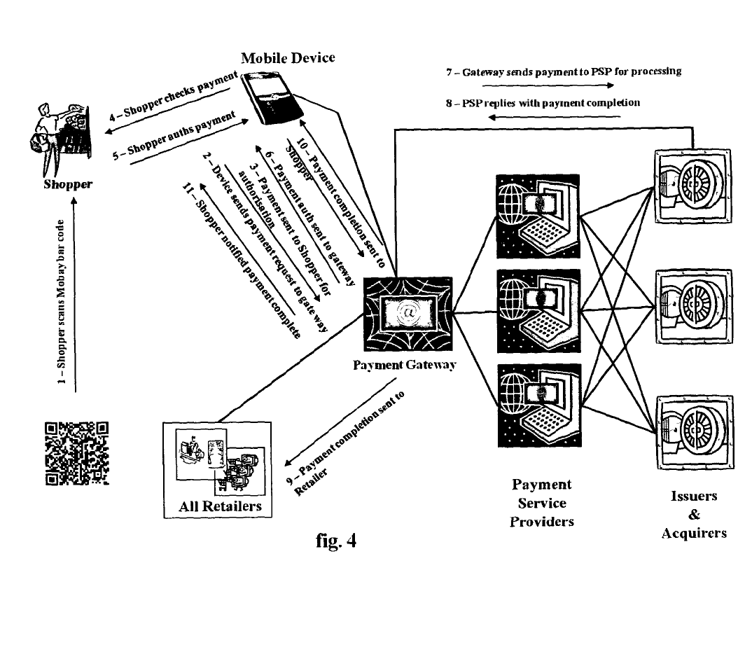

The Mobay Payment Gateway can take payments not just in retail stores or on-line but anywhere in the real world. Mobay Merchants can tag items with bar codes or RFID tags or similar/comparable technologies on posters, on newspapers adverts, on magazine adverts, promotional emails and leaflets, or even during online infomercials, viral videos, pre-rolls, post-rolls, banners, or TV commercials. In fact payments can be taken anywhere a barcode can be printed or shown or wherever an RFID tag, or other similar method, can be embedded. The process for taking these real world payments in depicted in FIG. 4. When making a payment in the physical world the process is as follows: A Shopper sees an item they wish to purchase tagged with a Mobay bar code or RFID tag. The shopper opens the Mobay application on their mobile device and scans the bar code or RFID tag. The mobile device sends the payment details top the Payment Gateway. The Payment Gateway checks that the details are the Shopper is a valid user of the system the Gateway checks with the Retailers database for stock and pricing. The Payment Gateway then sends the Payment authorisation request to the Shopper as in the previous scenarios. The Shopper checks the payment details on their device and if the Shopper is happy with the payment requests the Shopper is guided through a number of screens allowing them to choose the payment instrument (Card type or bank account etc.) and the shipping address. The Shopper presses the Pay button and is then prompted for their PIN code (either 4 or more numbers or an alphanumeric code) associated with their Mobay account.

The mobile device sends the Shopper authorisation along with the PIN to the Payment Gateway. The Payment Gateway does a security check on the incoming message to confirm that the Shopper did in fact authorise the payment. Then the payment is sent to a PSP or directly to an Acquirer as in the previous scenarios. Payment authorisation is returned from the PSP or Acquirer to the Payment Gateway. The Payment Gateway then relays the purchase request along with the Shopper and payment details including the authorisation to the Retailer. This allows the Retailer to then dispatch the goods to the Shopper and if the Shopper is new to the Retailer they can add them to their database for future reference. The Payment Gateway will also send a payment confirmation to the Shopper via SMS, Email and a message on the Mobile device.

### Mobay Peer-to-Peer Payments

It is also possible for users of Mobay, both shoppers and retail merchants, to directly pay each other using the Mobay mobile device application. This is especially useful for small retailers without a web-site or retail POS infrastructure (e.g. trades men) or friends to pay each other or even to pay for items bought on an on-line auction. This facility could become very popular especially if the planned phasing out for paper cheques goes through. To receive Peer-to-Peer (P2P) payments the recipient registers a valid bank account with Mobay. The cost of the P2P payment can be either borne by the sender of the payment the recipient or shared between the two. P2P payments can be made with the peers in close proximity, or at the other end of a telephone line or even via email.

Sending a Payment. The first scenario of a P2P payment is the payment sender initiates the payment. To make a P2P payment a Mobay payment sender starts up the mobile application and enters the Mobay identifier of the payment recipient and the amount they wish to pay. Entering the Identifier could be just typing it in, using RFID enabled phones, Blue Tooth, barcode scanning or any other acceptable method. The sender presses the send button on the application and the payment request is sent to the Mobay Payment Gateway. The Mobay Payment Gateway validates both the user making the payment and the payment recipient as valid Mobay P2P users. The Payment Gateway then sends the details of the recipient to the sender making the payment to confirm they have the correct recipient. If they are still happy with the payment they proceed in a similar way to previous examples. The sender presses the pay button as before and enters their PIN. This forms a payment authorisation which is sent to the Payment Gateway. The Payment Gateway notifies the recipient of the payment request and the terms of the request. If the recipient agrees with the payment including the terms of the payment, such as whom bears the cost of the transaction, they accept the incoming payment. The Payment Gateway processes the payment via a payment processor such as a PSP or an Acquirer directly. Upon successful authorisation via the payment processor the payment sender is notified that the payment has been made successfully as is the recipient of the payment. At a later stage the funds are transferred to the recipient's bank account at which point both payment sender and recipient are notified.

The cost of the transaction can either be borne by the sender, the recipient or shared by both peers of the payment. This is negotiated at the time the payment is being made by an option on the payment application. When sending the payment request the user chooses who pays for the transaction, sender or recipient or shared. The recipient when notified of the incoming payment has the option of agreeing the payment terms or rejecting the payment.

### Requesting a Payment

Mobay P2P users can also request payments from other Mobay users with their mobile device and the Mobay mobile application using a process is very similar to send a payment. The payment recipient starts by entering the Mobay identifier of a Mobay user they wish to request payment from along with the payment amount and the payment details. This is sent to the Mobay Payment Gateway as a request for payment by the mobile device. The Payment gateway validates the Mobay user requesting the payment and the user the payment is being requested from. Mobay users may have to pre-register to accept incoming payment requests as a security measure. If the payment request is valid the request is sent to the user being requested to make the payment. As with the previous scenarios the users checks the payment details and the cost of the payment (i.e. Recipient is paying the processing cost, Sender is paying or shared) and if they are happy with the payment they accept it. Accepting the payment is as before which includes entering a PIN code. The payment is processed and the Recipient and the Sender are again notified of the successful completion of the payment. At a later stage the payment amount is transferred from the senders to the recipient and again both peers can be notified.

### Key Functions of the Mobay Payments Gateway

This section details some of the key functions of the Mobay Payments gate way outlined in the previous sections.

The mobile device used to make payments will mostly be a mobile phone but other devices such as iPad type devices and PDA's can also be used. All that is required is a connection to the internet/worldwide web, or connection to an intranet, via any means including but not limited to Wi-Fi, 4G, 3G, GPRS and Edge. More limited functionality can also be provided by using SMS as the communications channel when internet connectivity is not available. The application can be developed to run on all the major mobile operating system including but not limited to IOS (apple), Symbian (Nokia), Windows mobile (Microsoft), RIM (Blackberry), Android (Google) and mobile Java. The application will be an intuitive feature rich application that handles the entire payment process from the shopper's point of view. It may be available free of charge to any users of the Mobay platform. The application can be used to sign up to Mobay and set-up the Shoppers Mobay account using secure protocols. This will include entering the Shoppers personal details, payment instrument details and could include shopping preferences such as preferred delivery address and payment methods. By using the application to enter sensitive data such as card details the shopper is better protected against on-line fraud and hacker attacks (see security below). The application also supports functions to allow Shoppers to share their shopping experience with other Mobay users or even with social networking websites. This can include rating products, services and users. The application can also support sending purchase recommendations to other Mobay users which they can proceed to purchase if they wish via the application.

Whilst the preferred method of communication between the gateway and the mobile device is network based e.g. 3G, Wi-Fi etc a system of encrypted bar codes could be utilised along with numeric codes. Whilst not ideal this fallback method of communication could be used when there is no network connectivity.

For instance, when shopping online instead of sending a message with the payment request via the network an encrypted barcode could be displayed on a screen which is scanned by the mobile device. The application then generates a numeric code in response to the Shoppers instructions which the Shopper types into the retail website.

### Application Look and Feel

The application will support dynamic look and feel to give the Shopper a better payment experience by dynamically applying Merchant colour schemes, logos, fonts etc so that the Shopper is confident they are paying for the products via the Merchant they were expecting.

The application may also display the items along with a description of they are buying for further verification of the transaction.

### Shopper Take-On

New shoppers have to sign-up to Mobay to use the Mobay platform for making and receiving (P2P) payments. This process can be done entirely via the Mobay mobile application or a combination of the Mobay application and the Mobay Shopper web-site. The shopper downloads and installs the Mobay mobile application on to their mobile device. During the installation of the application the user is guided through a number of security steps that results in the application being uniquely registered to that user on their mobile device (a user can register more than one device to the same account for making payments). Part of the registration process involves the user receiving a unique Mobay identification number, a 4 or more digit PIN code, one or more cryptographic keys and a password. The password is used for accessing the Mobay Shopper web-site. Once installed the Shopper can enter all their payment instruments they wish to use for making payments including Credit and Debit cards and Bank accounts. A Shopper needs to register a Bank account if they wish to receive payments using P2P. Once setup the Shopper can proceed to make purchases via any retailer accepting Mobay payments following any necessary security checks.

### Merchant Take-On

Merchants apply to be able to take Mobay payments either by contacting the Mobay payments sales line or more commonly via the Mobay website. The take-on process involves Merchant providing details of their business, the types of payments they wish to take and the payment processor (PSP, Acquirer or Mobay PSP) they wish to use. In some cases the Merchant may of more than one processor. Once all the relevant details are collected from the Merchant the relevant checks are made to assess whether Mobay wishes to take the merchant on. This could include checks on the business and security checks to assess the Merchants level of risk. Based on the type of business, the facilities the Merchant requires, payment volumes and relevant risk the Merchant can be offered a contract which includes amongst other things a cost per transaction for each payment type and payment terms. For smaller Merchants Mobay can offer a merchant account via the Mobay global account. This means that Mobay processes payments via the Mobay global merchant account and pays Merchants once funds have cleared into its account.

### Payment Load Balancing

A key and unique function that the Mobay Payment Gateway offers is Payment Load Balancing. This is where a Merchant is registered with a number of payment processor (either PSPs or Acquirers) and the Gateway spreads payment requests across all of the Merchants payment processor using a pre-defined algorithm. A major issue amongst current PSPs is transactional throughput and resilience which can especially affect large volume events. For example a release of a new video game or a release of poplar concert tickets. This can involve major bottlenecks at the Merchants payment processor and in some cases embarrassing outages. By spreading the load via the Mobay Payment Gateway across a number of payment processor this issue can be eliminated.

The Shopper website can be used by the Shopper to manage their account although all the functions available on the site are also avail via the mobile application. The site offers added convenience to the shopper when making changes to their account or wishing to look at their payment history. The website can also offer help to the Shopper such as supporting payment issues and merchant issues.

The Merchant Website is used by Mobay Merchants to manage their Mobay account. Through the website the Merchant can carry out numerous functions, including but not limited to:
Change the payment methods they wish to accept
View reports on payment
Check their account status e.g. payments pending to the Merchant
Change their password
Change their preferred payment processor
Add new payment processor
Change their risk checking configuration
Change their details

### Security

Another key and unique feature of the Mobay Payment Gateway is the way in which the mobile device and/or application is used to make payments for on-line purchases and the unique way it links retail websites to the Shopper via the mobile payment device. This provides industry leading security by separating the shopper channel i.e. the website from the payment process i.e. the Mobay Payment Gateway coupled with the Shoppers mobile device.

### Only Payment Processors See Card Details

Due to the unique way the Mobay Payment Gateway works merchants never need to see Shoppers card details. This is particularly useful in the on-line world where card details are intercepted by various attack methods. This also helps in the physical world where card details are copied using various techniques such as card skimming or just plain looking at the details and writing them down. The Mobay Payment Gateway only sends card details to payment processors such as PSPs and Acquirers using industry standard security protocols. Because card details are only ever passed between Tier 1 authenticated card processing systems the safety of the Card details is very high.

### Fraud Attack Prevention

Mobay provides a solution to one of the key mechanism that fraudsters use to capture card details whilst Shoppers are using on-line retailers. Some of the more well-known are Man-in-the-Middle (MITM) and Man-in-the-Browser (MITB) and Phishing attacks. In cryptography, the man-in-the-middle attack (MITM), bucket-brigade attack, or sometimes Janus attack, is a form of active eavesdropping in which the attacker makes independent connections with the victims and relays messages between them, making them believe that they are talking directly to each other over a private connection, when in fact the entire conversation is controlled by the attacker. The attacker must be able to intercept all messages going between the two victims and inject new ones, which is straightforward in many circumstances (for example, an attacker within reception range of an unencrypted Wi-Fi wireless access point, can insert himself as a man-in-the-middle). Man-in-the-Browser (MITB), a form of Internet threat related to Man-in-the-Middle (MITB), is a trojan that infects a web browser and has the ability to modify pages, modify transaction content or insert additional transactions, all in a completely covert fashion invisible to both the user and host application. A MITB attack will be successful irrespective of whether security mechanisms such as SSL/PKI and/or Two or Three Factor Authentication solutions are in place. The only way to counter a MITB attack is by utilising transaction verification. Whilst the Man-in-the-Middle attack is difficult to achieve the Man-in-the-Browser attack is less so. A large number of home PCs are infected by all sorts of trojans and other types of malicious viruses. One of the most effective methods in combating a MITB attack is through an out-of-band (OOB) Transaction verification process. This overcomes the MITB Trojan by verifying the transaction details, as received by the Payment Gateway to the Shopper over a channel other than the browser; which is exactly what the Mobay system achieves by using the mobile device and connection OOB. OOB Transaction Verification is ideal for mass market use since it leverages capabilities already in the mobile device and requires no additional hardware devices yet enables Three Factor Authentication, Transaction Signing (to non-repudiation level using industry standard cryptography), Transaction Verification and user authentication with a one time passwords used to connect the mobile device to the Gateway. A fourth factor could be added which would be some form of biometrics such as voice, visual or even fingerprinting authentication if the mobile device supports it. A fifth factor of authentication could be to utilise the location of the mobile device; this could be by GPS if the device supports GPS or location via the base station network. This will allow the Gateway to check that the Shopper is in fact in the location where the transaction is taking place in store or is not in a region of the world the Merchants do not want to receive payments from. In the field of computer security, phishing is the criminally fraudulent process of attempting to acquire sensitive information such as usernames, passwords and credit card details by masquerading as a trustworthy entity in an electronic communication. Communications purporting to be from popular social web sites, auction sites, online payment processors or IT administrators are commonly used to lure the unsuspecting public.

Another unique feature is the concept of Virtual Credit cards which can be issued by participating Card Issuers to significant strengthen on-line and off-line payment security. The Shopper applies for a Virtual Card in the usual way but upon successful completion of the application process the Card is never sent to an individual but instead electronically to the Mobay Payment Gateway.

Therefore the Card details have never been seen or will never be seen my Human eyes which greatly increases the security of the payment instrument. I.e. the Card can only be used via the Mobay Payment Gateway and not by any other means which could compromise the card details.

The Mobay Payment Gateway will support, if necessary, card scheme security features such as Verified by Visa and the use of Card Verification Values.

### On-Line and Mobile Banking

Whilst this system was initially designed to support retail payments it is equally suited to online banking. When an online retail bank user attempts to make a payment transaction the bank's system will send a digitally signed and encrypted message to the mobile device via the Mobay gateway. The user will read the details on their device and if happy with the payment instructions authorises the payment with a PIN code (PIN code is optional depending on the level of security required).

The mobile device will send the digitally signed authorisation back to the retail bank which in turn will check the authenticity of the response. If the authentication is valid the payment will be processed.

This method of digitally signed messages ensures that the payment instructions have not been tampered with in any way by MITM and MITB attacks. It also protects against phishing attacks as the message could only have come from the bank if it has been correctly signed.

The Mobay application could be used to generate one time passwords for logging onto an online banking system This one time password can be used in conjunction with the users other login credentials to add further security to online banking.

Once logged into the online banking system the user can be notified when significant events occur during the online session. This will include financial transactions such as setting up of new payment instructions, changes to personal details, sending money or any other significant event.

This allows the user to validate that what they are doing via the online banking system has not been tampered with by a third party. The application can also generate one time passwords for authenticating transactions or changes to sensitive personal information. Some mobile operators and Card Schemes are experimenting with locating Payment Instruments (i.e. credit cards) within the mobile phone by either incorporating the details into the SIM card or within a memory chip. The Mobay system could use these in device payment instruments. For example when shopping online the process could be the same as when the Shopper has stored their card details with the Mobay Gateway except the mobile application will extract the card details from the mobile device and send them along with the authentication to the Gateway. The Gateway will continue processing as before. The Mobay Payment Gateway can directly support Merchant loyalty schemes e.g. TESCO Club Card. When the user makes payments using Mobay Payment Gateway points will be added to their loyalty schemes in the usual way. The mobile application will allow the Shopper to view points balances and spend the loyalty points whilst making payments with a participating Merchant. Merchants can also give Shopper vouchers that they can spend via Mobay Payment Gateway buy adding these to their loyalty account. Mobay can also allow aggregation of one or many loyalty schemes that the shopper may be participating in. The shopper may be able to choose one or more loyalty schemes in respect of which the points will apply. This could for example be a product which gathers points from the manufacturer, whilst at the same time generating points for the shopper from the merchant.

From the Merchants perspective, Mobay could prevent aggregation of one or many loyalty schemes that the shopper may be participating in, and prevent multiple points accumulation.

### Mobile Ticketing/Near Field Communications Devices

Some early pilots of mobile ticketing have been introduced around the world with varying degrees of success. These mobile ticketing schemes could be hosted by the Mobay Payment Gateway giving Shoppers a single application to do all their mobile payments whilst at the same time holding mobile tickets within the same application. When the Shopper buys a mobile ticket using the Mobay Payment Gateway it is stored within the Shopper's Mobay account. When required the Shopper calls up the ticket from the Mobay mobile application and presents the ticket to the ticket reading device. The ticket reading device could be a barcode reader or an NFC device such as that used for TFL Oyster card. The Mobay Payment gateway can offer advertisers unique advertising opportunities due to the data stored about users shopping habits and demographics. Advertising can be anything from emails with barcodes as describe above for products or services or banner adverts both within the mobile application and the Mobay Shopper website.

Advertisements can be even more targeted by using the mobile devices GPS location services to advertise products and services in the Shoppers vicinity—either local or in-store. The location could be determined by the merchant's address, or the location of the store, or by GPS, or by the wireless network co-ordinates. The targeting can take place as the shopper comes into store, or at the till, or after leaving the till.

The Mobay Payment Gateway can allow shoppers to carry out price comparisons of products in different virtual or real stores. In the case where the products or services are available on-line the mobile application could open a browser window and direct the Shopper to the product on the retailer's web-site. The Mobay Payment Gateway can allow shoppers to see their monthly bills and usage in types of stores or types of products or similar. The Mobay Payment Gateway can allow merchants and shoppers to enable delivery of paperless receipts. The receipts could be stored on the server, or on the device, or aggregated and sent to the shopper. This would save money spent by merchants on generating till receipts, and would be useful for consumers. Receipts could be digitally signed to allow authenticity to be check when the receipt is used for refunds.

An application programming interface (API) can be provided to allow developers of mobile applications, mobile websites and standard websites to use the Mobay gateway for payment processing. This will allow developers to handle in-application purchases on mobile with Mobay either using the mobile Mobay application or directly with the Mobay gateway.

It will also allow developers of mobile websites to provide a simplified and secure payment experience for on-line Shoppers.

There are an ever increasing number of mobile wallets where Shoppers create an account and enter one or more payment instruments to use for further payments. PayPal and Amazon are two examples of mobile wallet providers. In order to simplify the set up process for users, Mobay could allow Shoppers to add other mobile wallets to their Mobay account. Mobay would then use these third party mobile wallets to make payments where appropriate.

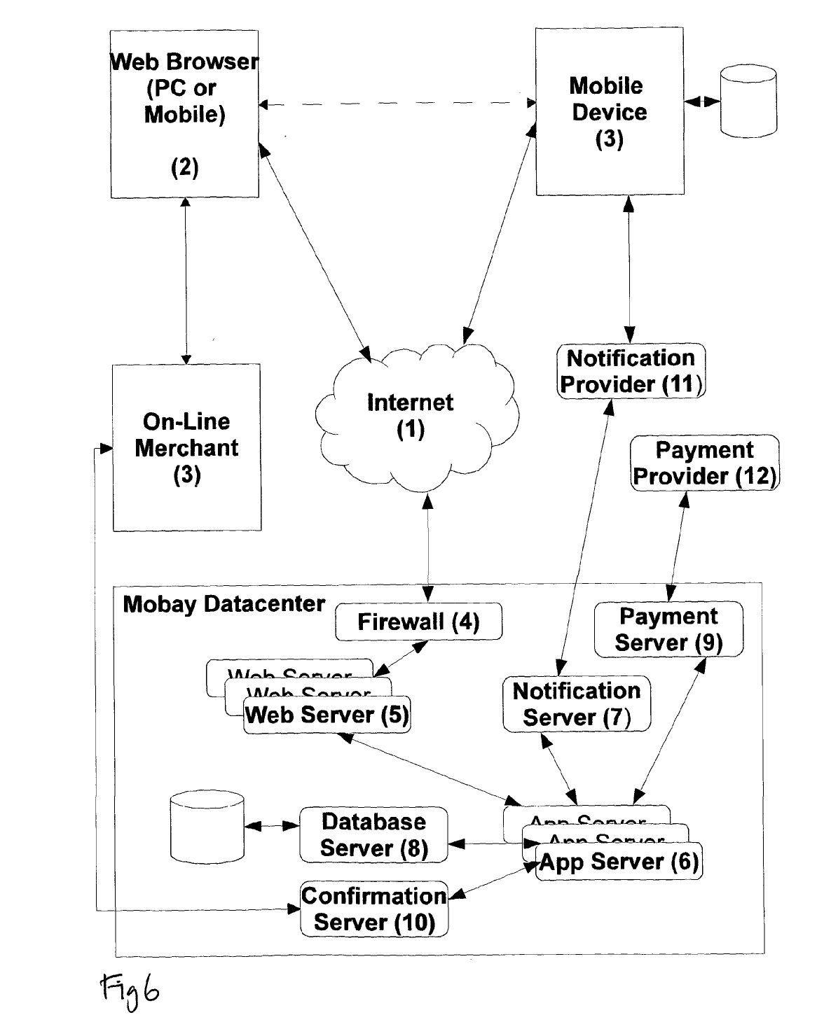

FIG. 6 outlines the key components of the Mobay Payment Gateway (MPG):

### 1—Internet

This component represents the Internet and its components such as IPS (Internet service providers). It also represents both Mobile (GRPS, Edge, 3G, 4G etc) and wired (home and office broadband) internet components.

### 2—Web Browser

This component is a standard web browser (1E, Safari, FireFox, Crome etc.) running on any device capable of running a web browser including office or home Personal Computers (Apple Mac, Windows PC, web on TV) and mobile devices (mobile phone, tablet computer e.g. iPad, TV).

### 3—On-Line Merchant

This component is any online retail merchant, whether the merchant's store is accessible via on online store, or via a mobile focused store, or within a portal or a walled garden or a community or network.

### 4—Firewall

The firewall component is the main entry point into the MPG from the public network (the Internet). This component may be one or more physical items that make up the security infrastructure of the MPG.

### 5—Web Server

The web server component is a standard Internet web server that is used for serving the static content of the MPG to connected web browsers. Both Merchants and Shoppers will use these web servers to access and administer their accounts. The will be a number of web servers depending on the load requirements with the load capable of being balanced across all of them for performance and resilience.

### 6—Application Server

The application server can provide the main application services of the MPG and can use an industry standard application container such as Tomcat. There can be one or more application servers dependant on load requirements with the load capable of being balanced across all of them for performance and resilience.

### 7—Notification Server

The notification server is responsible for storing and forwarding notification requests for new payment requests to Mobay shoppers. The notification server will send notifications to mobile devices via secure notification providers (such as Apple Corps. APNS system).

Separating the notification system from the core application server (6) is one of many key features as it simplifies the design by de-coupling the details of the notification system from the core application. It also improves the robustness of the architecture, improves flexibility of the MPG and provides more security and scalability options.

### 8—Database Server

One or more databases will be required to store merchant, shopper, card, payment, processing details. The number and type of databases will depend on the final detail design but industry standard Relational databases (Oracle, Sybase, Mysql) and high performance non SQL databases (Cassandra) can be used to improve performance and scalability.

### 9—Payment Server

A payment server is responsible for secure communications between the MPG and payment service providers. The payment server will forward payment requests to any payment provider including on-line PSP's (Payment Service Provider e.g. SagePay), Acquirers (e.g. Streamline) or any other type of secure payment provider. The choice of payment provider will usually be the choice of the retail Merchant.

Separating the payment server from the core application server (6) is one of many key features as it simplifies the design by de-coupling the details of payment processing from the core application. It also improves robustness of the architecture, improves flexibility of the MPG (e.g. makes addition of new providers simpler) and provides more security and scalability options.

### 10—Confirmation Server

A confirmation server is responsible for sending payment confirmations to both the Merchant and the Shopper. When a payment has completed a message using email, or HTTP or any other protocol is sent to the Merchant to confirm the completion status of the payment and the Shopper details for sending goods to. An email is also sent to the Shopper confirming the Shopper payment completion status.

Separating the confirmation from the core application server (6) is one of many key features as it simplifies the design by de-coupling the details of confirmation processing from the core application. It also improves the robustness of the architecture, improves flexibility of the MPG and provides more security and scalability options.

### 11—Notification Provider

A notification provider is a trusted service (such as Apples APNS service) that is used to deliver payment request notifications to the mobile device. Each mobile device type (Apple, RIM, Android, Windows 7 and others) will have a dedicated 3rd party trusted notification provider.

For added security no payment, personal or card details need to be sent via the notification provider, only a notification that a payment is waiting is sent to activate the mobile application on the mobile device.

### 12—Payment Provider

A payment provider is a secure and trusted payment service provider such as an on-line PSP, a bank or any other payment provider that is authorised to process payments. Mobay can also provide payment processing services using a separate payment processing platform.

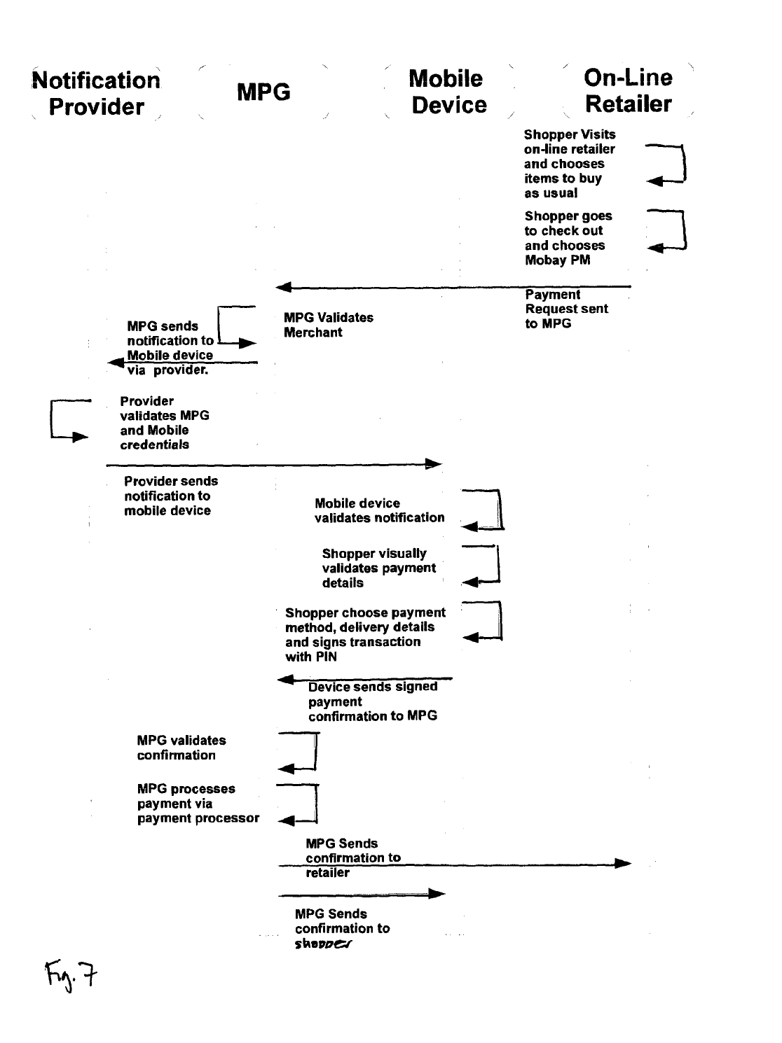

FIG. 7 outlines how an on-line Shopper uses the Mobay Payment Gateway to make a secure on-line payment using a standard web-browser and a suitable mobile device.

### Processing Details

A major concern for shoppers when transacting online, whether using a personal computer or a mobile device, is security. Many users do not shop on-line or limit the merchants they visit or limit the payment instruments they use due to security concerns. Despite a number of security measures there is still considerable on-line fraud committed further reducing consumers confidence. There are many well documented security threats such as man-in-the-middle (MITM), man-in-the-browser, card skimming, phishing and many more. The Mobay Payment Gateway is specifically design to reduce the opportunity of fraud using strong cryptography and other security measures.

The Mobay Payment Gateway uses strong public key cryptography (SSL or TLS) and signed certificates as the basis of its security. The follow sections detail how this is used by each component to ensure strong security at all times.

### Mobile Device Processes

Security starts with the mobile device when a shopper installs the Mobay mobile application on their mobile device. With some devices such as the iPhone added security is available via the manufacturer. In this case the manufacturer controls the distribution of applications to their mobile devices via an application store such as the Apple App Store. Developers, such as Mobay, are authenticated by the manufacturer and their applications digitally signed to ensure it cannot be tampered with.

During the installation process the application generates a Certificate Signing Requests (CSR) which is sent to a trusted Certificate Authority (CA). The CA responds with a valid Digital Certificate which is stored on the mobile device.

The shopper is also prompted for a user name and password which are stored encrypted on the mobile device and also sent to the MPG and stored as part of the users account.

The shopper is also prompted for a PIN which is only stored on the mobile device and is used to authorise payments.

A unique device ID is also generated by the application and signed using the Digital Certificate and stored on the mobile device and on the MPG as part of the users account. This process ensures that the server can trust the mobile device and the shopper using the device and the shopper (via the device) can trust the server (the MPG).

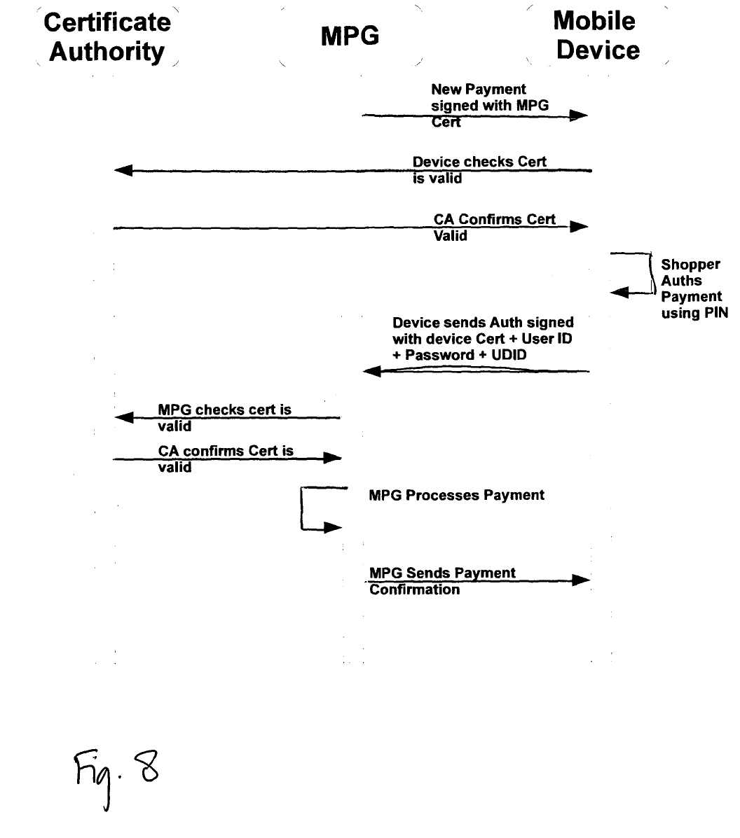

FIG. 8 is a drill down showing the communications between the mobile device and the MPG to highlight the security aspects: Using a one time password generator (OTP) the password sent to the MPG can only be used once for the current transaction. This ensures that in the unlikely event the Shoppers MPG account is compromised and the password and PIN exposed this data alone cannot be used to make payments with the Shoppers account.

### Merchant Processes

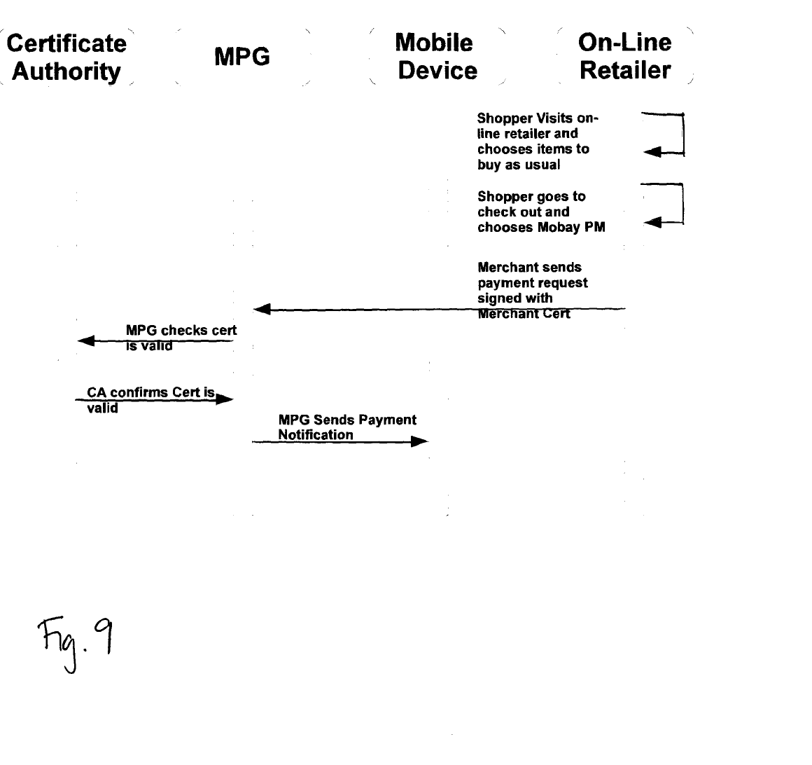

The Merchant can also be compromised especially when using simple account ID/Password combination to access a payment processor. To further strengthen security a Merchant can be furnished with a Certificate that is used to initiate transactions. FIG. 9 outlines the Merchant authentication process:

### Card Security

Card security is maintained as per the PCI-DSS requirements as required by the major card schemes for all payment card processors. This includes employing devices such as hardware security modules to manage encryption keys used to encrypt cards details as per the standard. There are there key aspects of the MPG with regard to Card security, Card Handling, Card Fragmentation and Issuer Authentication. However, most fraud happens outside the control of existing payment processor using attacks at the Merchant web-site or the Shopper computer.

To remove the attacks and vulnerabilities outlined above the MPG is designed so that the Shopper never enters card details onto a web-browser at any time including during the sign-up process and when purchasing items from a Merchant.

This also has the benefit of reducing compliance requirements for Merchants as with this model Merchants do not need to process card details.

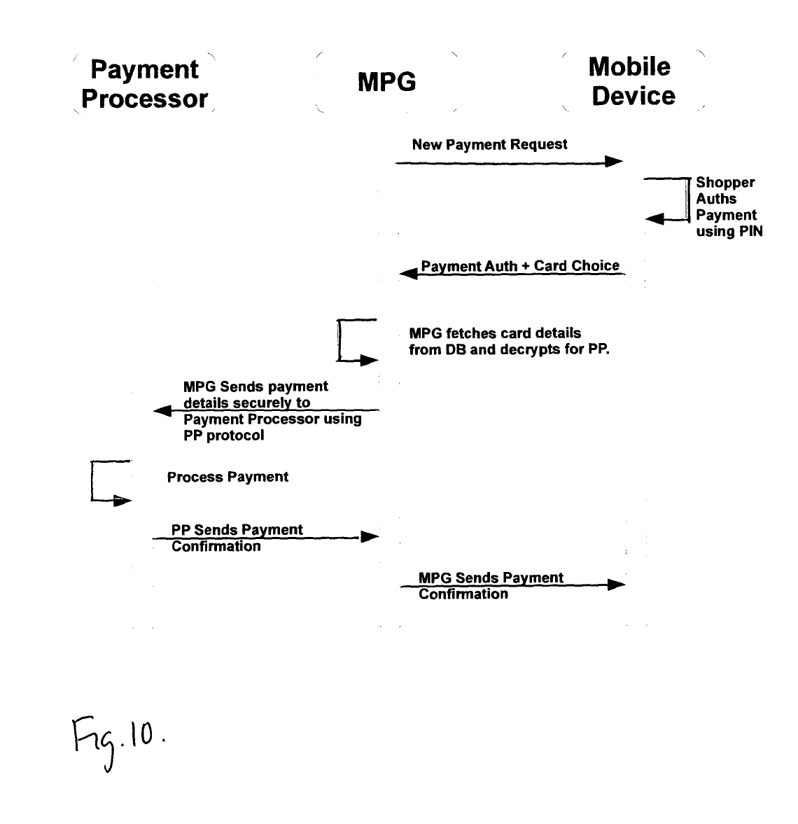

FIG. 10 outlines the card handling process:

### Card Fragmentation

To further enhance security and significantly reduce the risk of card compromise at the MPG, part of the card PAN (encrypted) is stored on the mobile device.

The PAN is the Primary Account Number that appears on a standard credit card or debit card. It has a certain amount of internal structure and shares a common numbering scheme. Credit card numbers are a special case of ISO/IEC 7812 bank card numbers.

An ISO/IEC 7812 number is typically 16 digits in length. It consists of a single-digit Major Industry Identifier (MII), a six-digit Issuer Identification Number (IIN), a variable length individual account identifier, and a single check digit calculated using the Luhn algorithm. The MII is part of the Issuer Identification Number (IIN).

When a Shopper first enters a new Card into the mobile device the Card it is encrypted using a key provided by the MPG. Normally, the complete encrypted card is sent to the MPG and stored as part of the Shoppers account. However, with this invention the encrypted card is split into two fragments, one stored on the MPG and the other stored on the mobile device.

During a payment the fragment of the PAN and or the Key is sent to the MPG to reconstruct the PAN during a payment. The reconstructed PAN is then sent to the Payment Processor (PP) to complete the Payment. The complete card in encrypted form is never stored at the MPG.

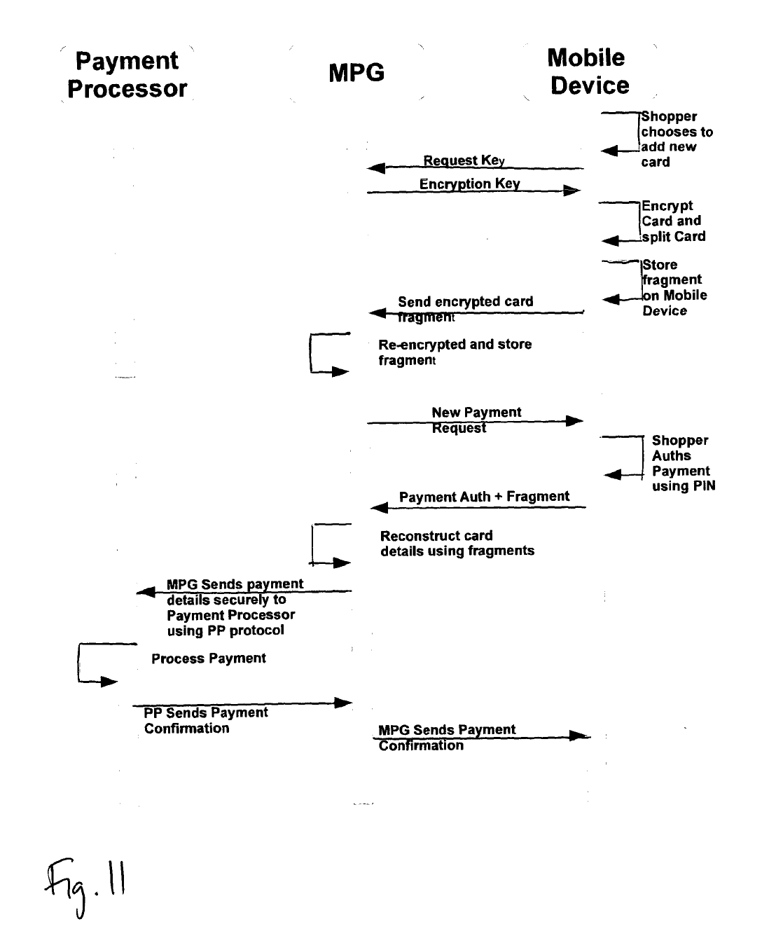

FIG. 11 outlines this process.

PAN fragmentation simplifies PCI compliance because there is no need to store all card details. The parts of the key to decipher the system are in two or more places.

PAN Fragmentation can be used in other systems where there are credit or debit cards (or other types of cards) as one can significantly enhance security by having the number in 2 or more separate places.

Whilst a high level of security is afforded by the processes outlined above this can be further enhanced by introducing the Issuer into the authentication process. This is achieved in two stages:
When the Shopper adds a new card and
During transaction processing.

### Adding a New Card

When a Shopper adds a card to their MPG account the application can connect to the Issuer and, using the authentication process with the Issuer, the mobile device is issued with a certificate by the issuer allowing them to use the card for future transactions via the mobile device. This certificate is only stored on the mobile/portable device and is unique to the device.

### Transaction Processing

When executing a new transaction the mobile device contacts the Issuer using the certificate (after entering the application PIN) requesting authority to proceed with the payment. The device sends a signed request (signed using the certificate) including merchant and payment details. The Issuer responds with a one time use, time limited, Payment Token for the payment.

The token is passed to the MPG which authenticates the token with the Issuer to check that it is valid. If valid the payment is processed as before, however, the token can also be passed to the payment processor which can also authenticate the token with the Issuer before processing the payment for added security.

### Further Enhancement

A further enhancement to this process can be to only send the token to the MPG and subsequently the Payment Processor. The Payment Processor then uses the payment token to process the payment either directly or via an Acquiring Bank. This way card details are never passed around any network, just tokens.

A further enhancement can be to never enter Card details into the mobile device but instead a token representing the Card details is provided to the Shopper by the issuer to enter into the mobile device to represent the card. In this instance a Card Token and the previously outline Payment Token is used to make payments instead of Card details.

This means that PAN's don't have to be visible to anyone except the Issuer. The token represents the PAN.

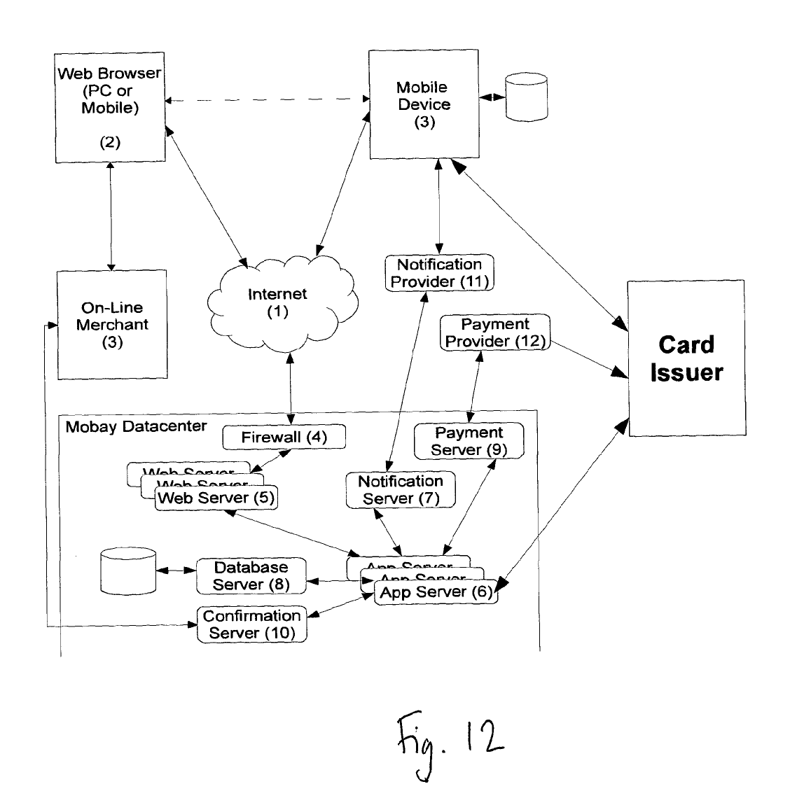

FIG. 12 shows where the Issuer fits into the high level design:

The communications to the Issuer could be direct or via the Issuer/Card Scheme network.

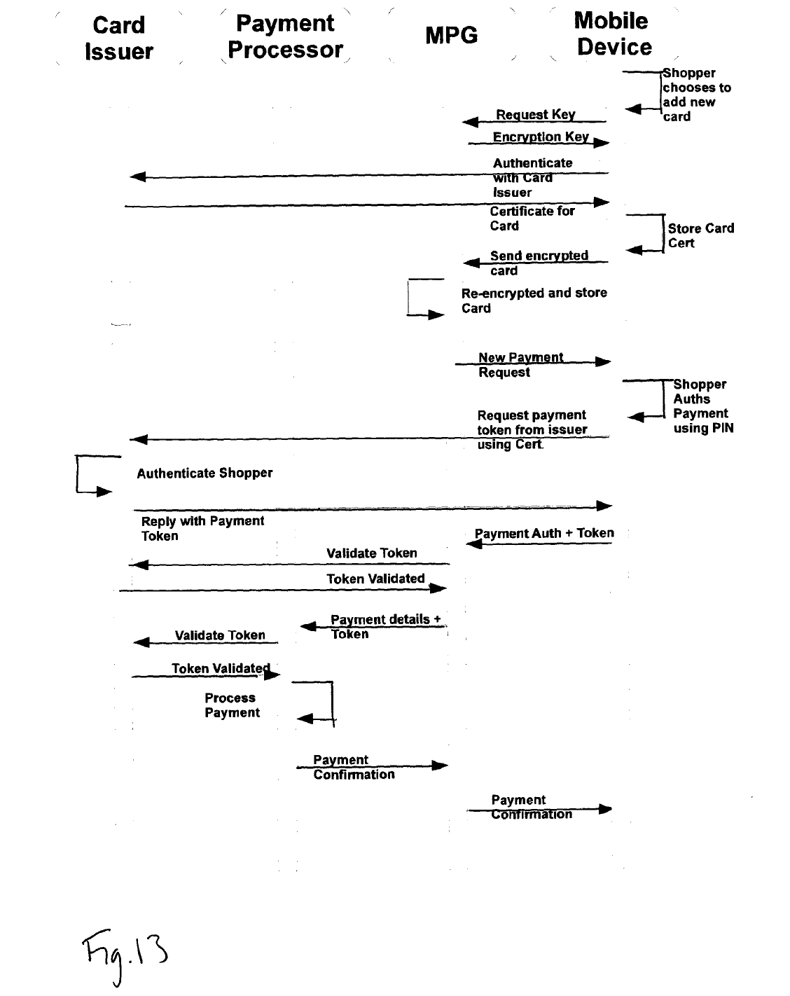

FIG. 13 outlines the payment processing using Issuer Authentication:

### Issuer Authentication

One Issuer authentication version is designed to use existing processes to minimise the time to market. A further method is an enhanced version where by the Issuer communicates directly with the Card holder (the Shopper) thereby simplifying the process, increasing rustiness and improving security. There are two versions of this process, when a card is used for the first time and subsequent uses of the same card.

### Transaction Process—First Time Use

When executing a transaction the Shopper chooses the card they wish to use or adds a new card via the Mobay application on their mobile device. The Shopper then enters their PIN to sign the transaction as before and the payment details are sent to the Payment Processor (Acquirer or Acquirer via a PSP).

The Acquirer contacts the issuer (in the normal way via the card scheme operator) for authentication. The issuer then contacts Mobay to authenticate the Shopper (i.e. to authenticate that the shopper is the holder of the card) including a challenge (a set of security questions for instance, this could include D.O.B, numbers from the Shoppers PIN code, a security token sent in the post etc.) and a token to represent the new transaction. Mobay sends a message to the Mobay mobile application requesting authentication.

The application displays the challenge to the Shopper and the shopper responds by answering the challenge questions.

The mobile application then sends the response to the Issuer directly with the token provided by the Issuer and the response to the challenge. The issuer validates the response to the challenge and if satisfied authorises the transaction and sends a certificate to the Shoppers mobile device.

This certificate is securely stored on the mobile device for use in future transactions.

### Transaction Process—Subsequent Uses

The process for using a card that has been used before is very similar to the New Card process except when answering the challenge. This time the Mobay Mobile Application sends the certificate (after the Shopper has correctly entered their Mobay PIN code) to the Issuer along with a password (which may be a one-time password using a one-time password system) and the transaction token. If the password is correct and the certificate is valid for the card (based on the token) is correct the transaction is authorised.

### Shopper Take-On

It is essential that the process of Shopper take on to be as simple as possible in order not to put off new MPG users but at the same time be as secure as possible. The security aspects must be an enhancement on the current measures afforded to on-line payments.

A Shopper new to Mobay must be able to choose the Mobay payment option on a browser and still be able to make a payment at least as easily as but more securely than present on-line payment systems.

When a Shopper sees the Mobay payment option on a retail web-site (on a desktop PC, laptop, tablet device, mobile device or any other device that can support a browser or application that can support payments) the user can choose the Mobay payment option.

The Shopper is prompted to enter their mobile number (this will later become their default Mobay ID which can be changed if desired by the Shopper). A text message is sent to the mobile device containing a download link to for the Mobay mobile application (MMA) and an authentication code.

The Shopper selects the download link and the application is downloaded and installed onto the mobile device. The application is started and on starting up the application reads the authentication code from the text message or the user enters the authentication code. This authentication code is used to validate that the user did indeed receive the text message.

The user chooses a PIN to secure the application and the data contained within it.

The application exchanges the necessary security keys and other security devices with the MPG and goes to the mobile payment screen to process the new payment.

As the Shopper is new the user enters their first Card into the application, enters billing and shipping addresses (usually via the address book to reduce typing). The payment is sent to the MPG and is processed.

This is the basic process but the process can also include Issuer authentication.

A Shopper can also go directly to the mobile device App-Store and sign up to the MPG without making a purchase. In this instance the Shopper can go to Mobay enabled retailers and instantly make payments using Mobay.

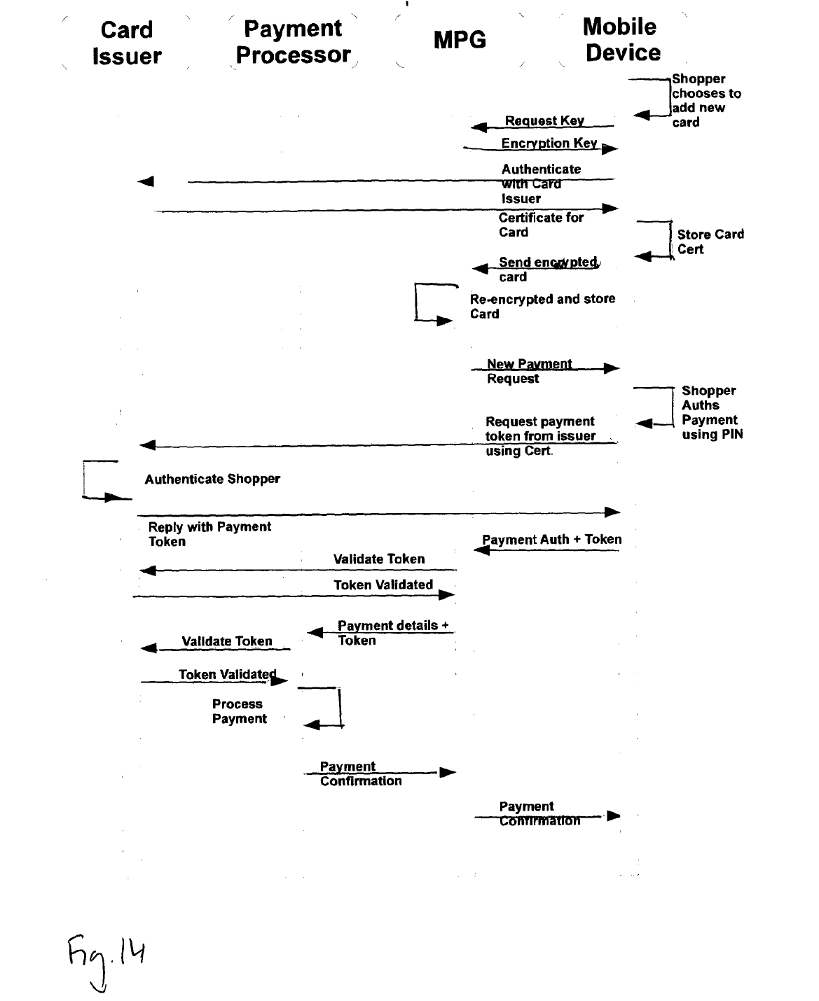

FIG. 14 outlines the Shopper Take-on process.

### Mobay 3D Secure Process Overview

PSP's, Issuers and Merchants implement 3D Secure differently and the invention can be used with 3D Secure to suit these varying implementations. However, the general design principles and data flows will be the same. The process works as follows:

Firstly, a Shopper will visit a Merchant and choose items to purchase that are added to their shopping cart. Once the shopping process is complete the Shopper will proceed to the Merchants checkout. At the checkout the Shopper will choose to pay using Mobay and as with all Mobay payments the payment details including the Shopper's Mobay ID are sent to the Mobay server.

The Mobay server will send the payment details to the Shopper's mobile device and the Shopper will accept the payment in the standard way using the Mobay application (as described in the Mobay functional specification) that includes entering their Mobay PIN into the Mobay mobile application to sign the transaction.

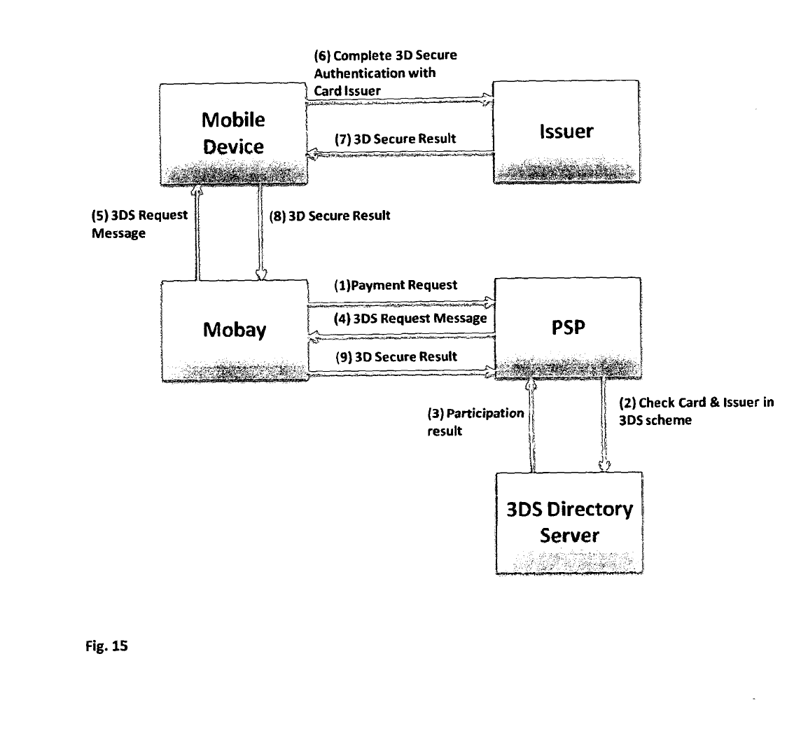

The Mobay server (following validation) will send the payment request to the PSP designated to process the Merchant's payments, this is shown as (1) in FIG. 15.

The PSP checks that the Card and the Card issuer are participating in a 3D Secure scheme via a 3D Secure Directory Server [2 in FIG. 15]. The Directory server will return the result to the PSP (3 in FIG. 15). If the Card is enabled for 3D Secure the PSP will send a 3D Secure request message back to Mobay (4 in FIG. 15). (5 in FIG. 15) The request message is then sent to the mobile device of the shopper to complete the 3D Secure authentication with the Card Issuer. The Shopper (via the mobile device) completes the 3D Secure authentication directly with the card Issuer (6 in FIG. 15). The card issuer returns the result of the authentication to the Mobile device that then forwards the result to the Mobay server. The Mobay server validates the result and forwards this to the PSP (9 in FIG. 15) that further validates the result. If the result of the 3D secure authentication is successful the payment continues as before. If the card issue is not part of the 3D Secure scheme or the result of a 3D Secure authentication is unsuccessful for any reason including; the Card Holder declined to authenticate, the Card Holder failed to Authenticate or any other reason, Mobay or the PSP will check the Merchant's settings to see what course of action to take. The Merchant may choose to proceed with payment if a 3D secure authentication failed or the Issuer is not part of the 3D Secure scheme, in which case the transaction will proceed as normal, otherwise the transaction will be terminated. The Merchant may also choose not to participate in the 3D Secure scheme and in this case the transaction will proceed without 3D Secure authentication although the Issuer may decline to authorise the payment.

Merchant Plug-In (MPI). 3D Secure processing requires an MPI (Merchant Plug-In) at the Merchant end to provide 3D secure functionality. In most cases (and as described here) the MPI functionality is provided by the PSP. However, some larger merchants implement an MPI directly, the invention can use this MPI in place of the PSP during the 3D Secure authentication process if the Merchant requires. Overall the process can work exactly as above with the exception that the 3DS result may be sent to the PSP at the end of the authentication process as part of the payment request.

Access Control Server (ACS) The ACS is the component that resides at the Card Issuer end of a 3D Secure authentication. Most Issuers outsource this functionality but this does not make any material difference to the inventions 3D Secure integration.

3D Secure Credentials. When a Shopper (Card Holder) first enrols into the 3D Secure scheme they are asked a series of questions to validate the Shopper. Once validated the Shopper creates a user name and password combination to be used with future 3D Secure authentications. If the Card has not been enrolled into the 3D Secure scheme the Card Holder will be given the option to enrol as part of their first transaction with the mobay provider. This is done securely via to a mobay provider mobile application. If the Card is already enrolled into 3D Secure the Shopper will be asked for the 3D Secure user name and password the first time the Card is used via Mobay. The 3D Secure credentials as securely stored within the system for future payments. This simplifies the 3D Secure process as future 3D Secure authentications happen automatically without any user intervention.

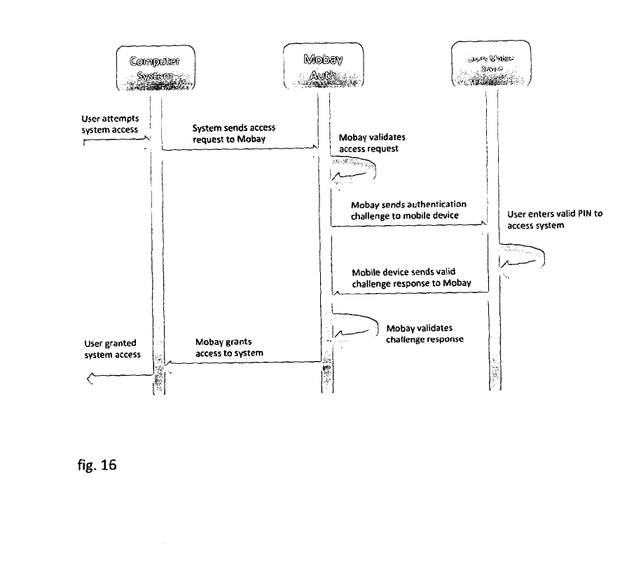

One of the major challenges with cloud computing is the potential security risk, with unauthorised people being able to gain access to networks and systems, notwithstanding the use of passwords. This invention is also a secure solution which gives computer users and businesses a new level of security. The invention comprises technology that requires people wanting to access their computers or networks to key in a pin code or passcode on their mobile, which will then unlock the computer or network. The invention can be used as a security measure to guard against unauthorised changes to systems or processes, as well as preventing unauthorised access to networks, systems and cloud based solutions. A process is set out in FIG. 16.

A computer user wants to access their computer. They key in their username to the PC or other computing device. A notification is sent via the Authentication Solution Provider (Mobay) to the user's mobile phone. The Mobay application pops up with a message saying that someone is trying to access the computer or the network, and asking for a pin code or passcode. The passcode is inputted into the secondary device. The device then notifies Mobay which sends an unlock code to the computer allowing it to be accessed.

A computer user wants to access their cloud based network. They key in their username and log in details. A notification is sent via Mobay to the user's mobile phone, or other authentication device. The Mobay application pops up with a message saying that someone is accessing the network, and asking for a pin code or passcode. The passcode is inputted into the secondary device. The device them notifies Mobay which sends an unlock code to the network allowing that users account to be accessed. The process could be varied to provide that the message is sent to another person's mobile phone (or multiple people) asking for permission to be granted for a person to access their computer, or their network, or application or specific information on a system. The Mobay authentication process could also be used to approve changes or releases made to a set of documents or codes. The person seeking to make the changes would only be able to make the changes if they sought third party authorisation to (from) the authorisers mobile phone/authentication device. So a database of information might be confidential, and if it was accessed, a notification would be sent to one or multiple authorised people. The notification would report that the database is being accessed by x person, and would ask for that access to be authorised or refused.

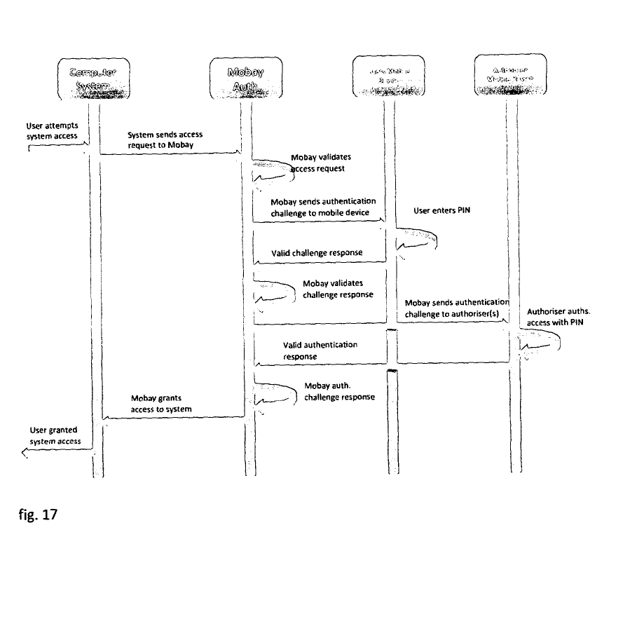

Multiple authentication could work according to the process in FIG. 17 when both the user and the authoriser both need to validate access to a system or specific data or files within a system or a network.

The system can be adjusted to request authentication from any combination of the user accessing the system requiring to authenticate via Mobay and a second, third or more subsequent authorisers requiring to authenticate access to the system or its data by one or more authorisers. Authorisation could be requested by just an authoriser and not necessarily by the user accessing the system, for example when a user has already gained valid access to the system but further authentication is required to access specific parts of the system or specific data held on the system being accessed.

The notification/authorisation process is not limited to 2 factor 2 channel authentication. It can be used with multiple factor, multi channel authentication, and with multiple people, as the situation demands.

The system is secured by using strong public key cryptography, message signing and one time passcodes to ensure maximum security. The mobile device being used for validation is secured such that only that device can be used for validation. One time passcodes are used to ensure message cannot be reused for authentication.

Location based authentication. In some cases there may be the need to authenticate further by using the location of the mobile (authentication) device to ensure that the user of the system is in an authorised location before being given access. To do this the authentication system can contain a database of valid access locations for each user and for each system the authentication system is being used for.

When a user attempts to access the system via the 2F2CA process described above or by any other valid process, the mobile device sends the authentication system its location. The location could be derived by various means, including but not limited to the following:
Base station identification; and/or
Mobile/authentication device GPS; and/or
Mobile/authentication device IP address; and/or
Femtocells; and/or
WLAN's or LAN's.

The authentication system looks up the location the mobile device provided in its database and only grants access if the location is within a location that is allowed access.

Further authentication can be provided by confirming both the device being used to access the system (laptop, desktop, tablet or any other device) is in the same proximity as the mobile device being used to authenticate access. This is done by calculating the location of the device being used to access the system using any available means such as IP address, GPS location (if available), base stations, femtocells, LAN's, WLAN's, or any other available means and only giving access if both the access device and the mobile authentication device are both within the allowable proximity.

1-72. (canceled)

73. A system for verifying electronic transactions, the system comprising:
a computer; and
a payment gateway server,
the computer operable by a user to initiate a purchasing transaction using a first application running on the computer, the purchasing transaction being processed by the payment gateway server in communication with the first application running on the computer,
wherein the payment gateway server is operable to communicate with a second application running on the computer, the second application running on the computer operable by the user to confirm that the purchasing transaction was initiated by the user,
wherein the computer is a mobile device, and when the user adds a card to their account associated with the payment gateway server the second application is operable to connect to the card Issuer and, using an authentication process with the card Issuer, the mobile device is issued with a certificate by the issuer allowing the user to use the card for future transactions via the mobile device, and wherein the certificate is only stored on the mobile device and is unique to the mobile device.

74. The system of claim 73, wherein when executing a new transaction the mobile device contacts the Issuer using the certificate, after entering the application PIN, requesting authority to proceed with the payment, the device sends a signed request, signed using the certificate, including merchant and payment details, the Issuer responds with a one time use, time limited, Payment Token for the payment, the token is passed to the payment gateway server which authenticates the token with the Issuer to check that it is valid, and if valid the payment is processed.

75. The system of claim 74, wherein, the token is passed to the payment processor which can also authenticate the token with the Issuer before processing the payment for added security.

76. A system for verifying electronic transactions, the system comprising:
a first computer;
a second computer; and
a payment gateway server,
the first computer operable by a user to initiate a purchasing transaction, the purchasing transaction being processed by the payment gateway server in communication with the first computer,
wherein the payment gateway server is operable to communicate with the second computer, the second computer operable by the user to confirm that the purchasing transaction was initiated by the user,
wherein the second computer is a mobile device, and when the user adds a card to their account associated with the payment gateway server the second computer is operable to connect to the card Issuer and, using an authentication process with the card Issuer, the mobile device is issued with a certificate by the issuer allowing the user to use the card for future transactions via the mobile device, and wherein the certificate is only stored on the mobile device and is unique to the mobile device.

77. The system of claim 76, wherein when executing a new transaction the mobile device contacts the Issuer using the certificate, after entering the application PIN, requesting authority to proceed with the payment, the device sends a signed request, signed using the certificate, including merchant and payment details, the Issuer responds with a one time use, time limited, Payment Token for the payment, the token is passed to the payment gateway server which authenticates the token with the Issuer to check that it is valid, and if valid the payment is processed.

78. The system of claim 77, wherein the token is passed to the payment processor which can also authenticate the token with the Issuer before processing the payment for added security.

79. A system for splitting/dividing up primary account numbers (PAN) wherein one part of the PAN is held on a portable device and another part of the PAN is held by a gateway server.

80. The system of claim 79, wherein the gateway server is a Mobay Payment Gateway server.

81. The system of claim 79, wherein when a shopper first enters a new Card number into the portable device the Card number is encrypted using a key provided by the gateway server.

82. The system of claim 81, wherein the encrypted card number is split into two fragments, one stored on the gateway server and the other stored on the mobile device.

83. The system of claim 82, wherein during a payment the fragment of the PAN and or the Key is sent to the gateway server to reconstruct the PAN during a payment.

84. The system of claim 83, wherein the reconstructed PAN is then sent to a Payment Processor (PP) to complete the Payment.

85. The system of claim 81, wherein the complete card number in encrypted form is never stored at the gateway server.

86-118. (canceled)
